(19) United States
(12) Patent Application Publication
(10) Pub. No.: US 2026/0194919 A1
(43) Pub. Date: Jul. 9, 2026

(54) INTEGRATED UNMANNED AND MANNED UAV NETWORK

(71) Applicants: THE GEORGE WASHINGTON UNIVERSITY, Washington, DC (US); THE RESEARCH FOUNDATION FOR THE STATE UNIVERSITY OF NEW YORK, Albany, NY (US)

(72) Inventors: Richard C. MILLAR, Lexington Park, MD (US); Robert Walter MEYER, Syracuse, NY (US)

(73) Assignees: THE GEORGE WASHINGTON UNIVERSITY, Washington, DC (US); THE RESEARCH FOUNDATION FOR THE STATE UNIVERSITY OF NEW YORK, Albany, NY (US)

(21) Appl. No.: 19/109,319

(22) PCT Filed: Sep. 8, 2023
(86) PCT No.: PCT/US2023/032289

§ 371 Date: Mar. 6, 2025

Related U.S. Application Data
(60) Provisional application No. 63/404,797, filed on Sep. 8, 2022.

(51) Int. Cl. G05D 1/69; B64F 1/36; B64U 20/80; G05D 1/226; G05D 109/22

(52) U.S. Cl. CPC G05D 1/69; B64F 1/36; B64U 20/80; G05D 1/226; B64U 2201/104; G05D 2109/22

(57) ABSTRACT

The operation of multiple unmanned vehicles (UAV) commanded and supported by a manned “Tender” air vehicle carrying a pilot and flight manager(s). The “Tender” is equipped to flexibly and economically monitor and manage multiple diverse UAVs over otherwise inaccessible terrain through wireless communication. The architecture enables operations and analysis enabled by means to detect, assess and accommodate change and hazards on the spot with effective human observation and coordination. Further, the optimal trajectories for UAVs to collect data from sensors in a predefined continues space. The system formulates the path-planning problem for a cooperative, and homogeneous swarm of UAVs tasked with optimizing multiple objectives simultaneously as its objectives are maximizing accumulated data within a given fly time and designed data clouding processing constraints as well as minimizing the probable imposed risk during UAVs mission. The risk assessment model determines risk indicators using an integrated

### CROSS-REFERENCE TO RELATED APPLICATIONS

This application claims the benefit of priority of U.S. Application No. 63/404,797, filed on Sep. 8, 2022, the content of which is relied upon and incorporated herein by reference in its entirety.

### BACKGROUND

In a world where time is of the essence, any tool that can accelerate the work time becomes a competitive advantage for manufacturers. This is also true in service industry and Unmanned Aerial Vehicles (UAVs) have attracted significant attention in this field. Since UAVs are flexible, portable, inexpensive, and convenient to use, they have been applied to perform various tasks in the areas of transportation, agriculture, healthcare, and heavy industry [1-6]. In particular, their effective deployment enable them being useful in situation where preparing wireless coverage to ground users is a challenging issue and the traditional cellular networks are sparse or unavailable such as rural areas.

The disclosure focuses on the potential uses of UAVs in the forest industry, and other applications are in the military industry. In the forest product industry, due to the fact that forest topography usually needs to be investigated, therefore, it seems that it is essential to have a UAV assisted data network which can provide coverage for the Internet of devices in areas such as forest topography.

In Canada and the U.S., forests may be less accessible for evaluation, reducing the value of the forest harvest and increasing costs, and risk for forest “scaling” to define costs and values, also accounting for estimated road building and clearance of undesirable tree species. In many circumstances, topography and difficulty of access, harvest and extraction are determinants of the cost and viability of the intended harvest.

In the past few years, significant advancements have been made in the field of air-ground collaborative systems. The Uninhabited aircraft systems (UAS) play a crucial role in these systems, encompassing numerous missions that are currently in operation or under consideration. Due to their agility, user-friendly nature, and ability to swiftly cover targeted areas, these compact robotic systems are utilized as mobile data gatherers, collecting and transmitting data to receivers (Hong & Shi, 2018). These tasks necessitate substantial degrees of connectivity and data bandwidth. While UAS are capable of covering expansive areas, their relatively small size and restricted payload capacities hinder their capacity to endure and establish consistent and dependable data connections. To address this issue, the utilization of advanced Internet of Things (IoT) technology may be employed as a solution to overcome the limitations of data capacity for UAS (Al-Khafaji, 2022).

Considering cybersecurity aspects, UAS are susceptible to potential hijacking or unauthorized manipulation. Furthermore, these systems have the potential to intrude into restricted areas, including airports and military airspace, without proper authorization. While the convenience of surveillance is a notable benefit of UAS, it can transform into a disadvantage of significant consequences when these systems are operated with malicious intent. As observed in the research conducted by Rudys et al. (2022), the central control system of UAS is susceptible to attacks, which could result in hackers gaining unauthorized control over the aircraft. According to Laghari et al. (2023), there is a risk of private data being extracted and subsequently tampered with or erased. Significant efforts have been made to enhance the precision of UAS control, adapting to the dynamic and intricate nature of the airspace. By implementing a more intelligent control system, it is possible to mitigate the risks that may arise from vulnerabilities in the open data communication system.

In order for an UAS to operate effectively, it must establish dependable communication with various entities present within its network. These entities include various types of aircraft and UAS, operators on the ground, global navigation satellite system (GNSS), and air traffic control (ATC) systems, among other elements. Furthermore, nations are in the process of developing remote traffic management (RTM) systems to seamlessly integrate advanced UAS into their national airspace systems, enabling their operation in conjunction with conventional manned aircraft. Other research endeavors described in the literature aim to enhance air-ground collaborative systems through the design and development of control mechanisms for UAS. Pastor et al. presented a comprehensive communication gateway architecture connecting UAS with ground stations. They demonstrated a hardware/software architecture specifically developed as avionics for controlling missions and payloads. The application architecture adopted a service-based approach, aligning with web-based and Internet paradigms. Gademer et al. demonstrated the attainment of centimeter-level data accuracy by UAS through the utilization of dedicated tools for operational mapping. Moreover, they combine satellite and vector information using a path optimization algorithm to generate meaningful flight schedules, which are constantly updated in real-time, ensuring thorough data coverage.

Aljehani et al. incorporated the UAS communication system into NTMobile technology, aiming to establish secure communication and provide support for UAS within a diverse network environment. The novelty of this study lies in introducing persistent connectivity to the UAS communication control system, even in situations where it needs to switch network access.

In a separate study, Seo et al. employed constrained combinatorial optimization techniques to address control, communication, and data processing time within Free-Space Optical (FSO)-based 6G UAS aerial networks. Within the realm of delivering FSO communication services, Alzenad et al. explored the viability of an innovative vertical backhaul/fronthaul framework. In this framework, networked flying platforms NFPs are utilized to facilitate the transportation of backhaul/fronthaul traffic between the access and core networks through point-to-point FSO links. Sabzehali et al. developed a model for data processing among UAS that ensures the signal-to-noise ratio SNR threshold is met. In their research, the network of UASs facilitates extensive connectivity coverage for backhaul and nearby ground-based stations GBSs. Zhang et al. put forward a two-layer UAS network, where the upper tier of UAS is responsible for managing connectivity with lower UAS and other control centers. They optimize the package delay for each UAS. In a similar vein, to minimize time delay, certain studies have taken battery consumption constraints into account. For instance, Bayerlein et al. proposed a path-planning problem to maximize collected data with the multiple autonomous unmanned aerial vehicles (UAVs) from distributed IoT sensor nodes. The formulated problem incorporated constraints related to flying time and collision avoidance, which were subsequently addressed using a deep reinforcement learning DRL methodology.

In certain publications, machine learning techniques have been employed by researchers to construct models for UAS control systems. In the recently published paper, Millar et al. presented a novel optimization model for path planning in which multiple UAS vehicles are directed and assisted by a piloted “Tender” air vehicle, which also includes a flight manager or managers. They establish the path-planning problem for a collaborative and varied swarm of UAS that aims to concurrently optimize multiple objectives. The primary objective is to maximize the accumulated data within a specific flight time while adhering to constraints related to cloud data processing. Additionally, they aim to minimize potential risks imposed during the UAS mission. Tang et al. conducted an exploration into the optimization of federated edge learning (FEEL) within UAS-enabled IoT for B5G/6G networks. They approached this optimization challenge using DRL methodology.

Douklias et al. meticulously developed and put into action a 13 kg UAS equipped with ample computational capacity and sensors, specifically designed to function as a specialized platform for evaluating image processing and machine learning applications. However, Zhang and colleagues presented an improved version of the deep deterministic policy gradient (DDPG) algorithm with the aim of resolving the problem of path-following control in UASs. They also developed a customized reward function aimed at minimizing the cross-track error associated with the path-following problem. In the domain of Multiple-UA Reinforcement Learning Algorithm, Zhan et al. developed an innovative algorithm specifically tailored for multiple unmanned aircraft (UA) reinforcement learning. This algorithm was particularly suitable for the self-developed Unity3D collaborative combat environment which served as the test scenario. They devised a task within this environment that necessitated heterogeneous UAs to engage in distributed decision-making and successfully accomplish cooperative objectives. Furthermore, the algorithm incorporates the inheritance training approach, which leverages course learning, to enhance the algorithm's ability to generalize and perform effectively in diverse scenarios. Syed et al. developed an innovative control and testing platform that utilizes Q-learning for a smart morphing wing system. This wing system was designed with the objective of achieving optimal aerodynamic properties. Mahmoodi et al. created a secure and robust multi-dimensional optimization model that leverages the NSGA-II algorithm. This model is designed to effectively handle data collection tasks in areas that have been affected by damage. By accurately defining the condition of flight trajectories, this model proves to be valuable for data collection purposes in such areas.

Clough introduced metrics to evaluate the level of autonomy in UASs based on autonomous control levels (ACL). These metrics were initially developed by researchers at the Air Force Research Laboratory's Air Vehicles Directorate, with the aim of assessing the degree of autonomy exhibited by autonomous air vehicles. The metrics serve as a means to identify and classify the level of autonomy in UAS. The ACL metrics, comprising of eleven levels ranging from zero to ten, have been effectively employed by the Air Force Research Laboratory to guide the development of autonomous UAS control research. These metrics have played a crucial role in formulating plans and programs related to autonomous UAS control research within the laboratory.

Chopra and Spong explored a fresh formulation that considers the coordination and synchronization of multiple UAS from an input-output perspective. Lyapunov Krasovskii theorems were employed to describe the exchange of information among agents over a network using an interconnection graph. The designed macro-level swarm behavior control scheme may not adequately consider the behavior constraints and uncertainties associated with each individual UA.

According to the findings of Bekmezci et al., it was determined that a direct connection of all UAS to an infrastructure, such as a ground base or a satellite, enables communication among individual UAS. However, this architecture based on infrastructure communication restricts the capabilities of the multi-UAV systems. These limitations include the need for costly and complex hardware for UAS, challenges in establishing reliable communication with other network devices, and restrictions in the communication range between UAVs and the ground base. The authors provided a formal definition of Flying Ad-hoc Network (FANET) and presented various application scenarios associated with FANET.

The latency time in the mission completion. Referring to FIG. 1(b), studies have designed UAVs trajectory planning adjusted to the possible causes of delay time in pertaining network connectivity. For example, in Lan et al., 2021 the authors optimize a multi objective UAV-assisted wireless communication system, including trajectory optimization, cache placement optimization, and power allocation optimization [9]. They minimize the mission time of the UAV with optimizing transmission power. Luo et al., 2020 develop a path-planning model to minimize the mission completion time, while they use an undirected weighted graph with enlarged GBS coverage. They illustrate that the connectivity outage constraint can be formulated as a flying area constraint. [10]. Cao et al. 2017 provided a cloud-assisted approach to obtain the optimum UAV's flight trajectories. Their model is featured according to the flying time, data acquisition, and energy consumption limitations. [11] In another study, Seo et al. 2020 used constrained combinatorial optimization with respect to control, communication, and data processing time for UAV aerial networks. In this study, optimization scheme has been developed subject to control and communication time constraints as well as processing time constraints in FSO-based 6G UAV aerial networks [12]. Zhang et al. 2020 proposed the two-layer UAVs network that top echelon of UAVs manage connectivity with bottom UAVs and other control centers. They optimize the package delay of each UAV. [15]. Asheralieva et al. 2019 introduced cloud-based content delivery networks (CDNs) which minimize the content transfer cost and delay, in their designed network, a set of clusters are set in a way that users in this cluster share their content throughout the D2D link established with the support of the cluster head.

Still referring to FIG. 1(b), the number of UAVs in a multi-UAV network is an indispensable enormous investment for every service provider. Hence, it is essential to reduce deployed UAVs in the network to ease the data processing and collecting performance. In the same approach, minimum UAVs have been utilized in the Sabzehali et al. 2021 model while the data processing between UAVs is examined by meeting the signal-to-noise-ratio (SNR) threshold. In their study, UAVs network supports maximum connectivity coverage for backhaul and nearby ground base stations. [13]. Battery consumption constraints have a role in determining the number of UAVs for example, Bayerlein et al., 2021 proposed the path-planning problem to maximize collected data from distributed IoT sensor nodes. [14]

As further shown in FIG. 1(b), transferring data across the entire UAVs assisted network initially is dependent on an amount of data that needs to be picked up over the whole mission time, i.e., the quantity of data to send/receive. Accordingly, the data volume of each (Internet of Things) IoT node concludes by relying on the communication time. It can be possible by minimizing the decoding error likelihood subject to the latency and location constraints. In research by Pan et al., 2019, and Luo et al., 2019, the data network model is designed to minimize the probability of decoding error in a joint block length allocation and the UAV's location optimization [10], [17]. To maintain a clear and consistent communication among IoT devices, the UAVs can establish a wireless link when the UAVs are located in the predominated altitude over them. For example, in Cui et al., 2019 research the UAV optimize its flight trajectory by maximizing the cumulative collected data from distributed sensors, while the location of sensors is optimized at the same time. [18]. Data transmission in a UAV assisted network need to satisfy required Quality of Service (QoS) during heavy traffic, Grekhove et al. 2021 provided this beyond the Fifth Generation (5G/B5G) wireless networks which supported by UAVs [19].

As further shown in FIG. 1(b), to evaluate the operational cost components of UAVs network, different methods have been conducted which stem from varieties of researcher's perspectives. For example, Zhang et al., 2020 designed a UAV assisted data network in which computation offloading, spectrum resource allocation, computation resource allocation was considered as the sources of expenses for the UAVs trajectory model. However, Dukkanci et al. 2021 proposed a UAV network delivery problem to minimize the total variable cost that consist of the operational cost of vehicles including trucks and UAVs and the cost of energy consumption arising from utilizing UAVs [20]. Dorling et al. 2017 proposed two multi-trip routing models for the cost-efficient UAV delivery, in which battery usage and payload weight is considered for cost optimization [21]. Zhao et al. 2017 considered fixed Cost of providing computing facilities as operational cost for UAVs and Base stations in their model [22].

As further shown in FIG. 1(b), Imposed Risks, for the reason that UAVs during data transmission need to be integrated with other IoT devices therefore, it makes them more prone to safety risks and security threats (Balador et al., 2018). [23]. Researchers have been deployed numerous measures to analysis possible imposed risk during UAVs operation. Millar et al. 2015 proposed a new risk analysis exploiting Bayesian belief networks (BBN) in support of interim flight clearance process. In BBN approach, they identified the casual factors which potentially contributing to the hazards and risks of experimental Unmanned aircraft system (UAS) flight test. [7]. In some studies such as Allouch et al. 2021 to improve the safety of the operation in the UAVs network, autonomous mechanisms have been designed in order to quickly response in the event of faults/errors. [24]

### SUMMARY

There is commercial interest in deploying UAVs to estimate these other costs and yields, but this effort is limited by government restrictions on UAV overflight restrictions, which require direct visual human surveillance and control of UAV operations. This may be a useful and viable option if a manned aircraft provides this function, essentially overseeing multiple UAV from a manned “Tender” vehicle, managing and reporting the status of all UAV operating beyond ground access.

One object of the present disclosure is to operate in missions multiple unmanned vehicles (UV), which includes Unmanned Aerial Vehicles (UAV) (UVs are sometimes generally referred to throughout this entire disclosure as UAVs, where the term UAV is intended to include other types of unmanned vehicles such as for example non-aerial vehicles), commanded and supported by one or more manned “Tender” air vehicles where there is uncertainty and risk requiring human surveillance. For example, missions in which line of sight or radio link may be interrupted, or other loss of functionality requires a “manned” backup capability. The entire mission is monitored to achieve the best UAVs flight trajectories while qualified data transmission is guaranteed across the whole of UAV network. Optimization has been conducted to achieve three specific objectives including: (1) maximizing the quality of data transmitted in support of UAVs network with respect to the time limitation range; (2) maximizing the quality of data clouding process prioritized based on significance; and (3) minimizing the imposed risk and hazards during operation.

A manned and unmanned integrated system and method is provided that integrates control, operation and data for both unmanned and manned UAVs. The system includes a data network based on combined bayesian belief network and multi-objective reinforcement learning algorithm. The system includes the use of multiple unmanned vehicles (UAV), commanded and supported by one or more manned “Tender” air vehicles. The Tender carries one or more human pilot(s) and/or flight managers equipped to flexibly and economically monitor and manage multiple diverse UAVs over inaccessible terrain through wireless radio communication. This is the main contribution of the present system, which makes it different from previous studies. The “Tender” vehicle suite of air-to-air UAV control and software is functionally similar to proven existing UAV “ground to air” management systems. In contrast, in our disclosure, the Tender aircraft vehicle architecture promises to facilitate analysis operations and, on the fly, enabling by multiple means to detect, assess and accommodate opportunities and hazards on the spot via unmanned radio.

The timeliness of data transmission is critical for the networks in which the updated information is needed such as search and rescue, surveillance, fire detection, disaster control, or target tracking. Moreover, in the case of the local memory of UAVs, data must be uploaded within a certain time, otherwise, it would be overwritten by new data [25], [26]. Thus, considering time windows in scenarios where the obtained data illustrates the current state of the target issues is essential and must be assumed in optimization. Therefore, in the present system, each time window determines when data transmission must take place. In this sense, the model (e.g., an algorithm) would be fine outside that timespan, be it later or sooner than the due time. This framework is implemented in the form of soft and hard windows, which are defined in detail in the methodology section. This concept is particularly useful in a data UAV network applied in the forest industry, in this field, the type of accumulated data such as tree species, their density, or even the trees' photosynthesis is time sensitive. The tree crown is the location of most photosynthesis, but it is difficult to view with the current technology, and observations from the ground. Viewed from above, the tree crown's coverage and capture of the sunlight can be ascertained unambiguously, and directly.

In the present UAVs network, real-time data is one basis of the right decision. To this end, factors such as limited computational capabilities of UAVs, Battery, and energy constraints of them or other IoT sensors are the major threats to UAV path planning or network topology control [27]. Cloud computing can readily tackle these limitations and support big data acquisition and processing [28]. In this disclosure, since multiple UAVs execute the complicated task, they are fitted with a variety of sensor payloads: cameras, various radars (including LIDAR), and other necessary sensors, plus autonomous flight navigation, sensor management, and raw data transmission to the ground control station. The size of the data volume would be approximately more than 150 Mbps [29]. Therefore, the collected data can be considered big data. Hence, as the second objective, a UAVs path-planning model (i.e., the risk assessment model) has been developed in which achieved data are stored based on their priorities. In the cloud-computing infrastructure, a significant correlation between clusters and nodes where data is collected determines their archiving sequence. The adaptability of the system to mount different sensor payloads on the UAVs makes the technology attractive to a wide range of military and S&T users: Marines (detection of chemical agents), Navy (low altitude meteorology for EO, radar, and HEL), Coast Guard/police (human detection for search and rescue), Forest Service (health of forests).

From the perspective of flight safety, the unpredictable conditions rooted in UAVs parts failures, environment disturbance or loss of wireless network communication generated enormous risks and hazards [30]. In the present system, the risk assessment model based on the Bayesian network is built. This architecture is effective in eliciting and ensuring consideration of a wide range of causal risk factors and multiple resultant hazard and risks. According to the established UAVs data network in the forest industry, we employed risk identification methods recommended by Joint Authorities for Rulemaking on Unmanned Systems (JARUS), Guidelines on Specific Operations Risk (SORA) [31]. SORA categorizes UAVs-operation against confronting two classes of risk, a ground risk class (GRC), and air risk class (ARC) [32]. Then, in following the SORA classification, for the next step, we built the relationships between the random variables through BBN. In this approach, reasons are identified for causal probabilities for scenarios given available evidence.

To verify the effectiveness of our theoretical analysis, we provide a reinforcement algorithm as it is one of the advanced machine learning methods capable of simultaneously coordinating numerous agents. [34] This coordination is based on a group of individuals that follows common simple rules in a self-organized and robust way [33]. It is developed based on UAV path planning optimization, in which the desired area is considered as a divided grid with finite space. UAVs move in the predominated space, from the state space to the action space.

UAV-assisted networks, based on the autonomous properties of UAVs, are applicable in variety of real time supply chain systems relied on data transmission streams. They can support wireless networks and be able to change their altitude, enhance coverage of wider areas, flexible path planning system, and improve line-of-sight (LOS) communication for possible terrestrial/aerial base systems. Single or a fleet of UAVs can be used in a large set of applications from rescue operations to event coverage going through servicing other networks such as sensor networks for replacing, recharging, or data offloading. Caillouet et al., 2020) [8]. Therefore, different features or requirements have been necessitated to maintain a real-time and reliable connectivity in the network. Based on these diversities, various analytical framework and mathematical models (as above) have been introduced by researchers and contributed accordingly. In general, Optimization theory, machine learning, stochastic geometry, transport theory, and game theory are used to address the UAVs problems.

Investigating UAVs' studies illustrated that; optimization is performed mainly for the objectives: (1) minimizing the latency in the mission completion time; (2) minimizing numbers of deployed UAVs; (3) maximizing the quantity of data to send/receive; (4) minimizing operational costs; (5) minimizing imposed risks; (6) minimizing energy consumption.

UAV problems have been modeled with respect to the various aspects of UAVs network. They can be optimized by either one out of above objectives or combination of them, or from the perspective of having base stations, authors can consider GBS and ABS simultaneously, or one of them.

Different possible modeling can be seen in FIG. 1(b). The risk assessment model determines risk indicators using an integrated SORA-BBN (the Specific Operation Risk Assessment-Bayesian Belief Network) approach while its resultant analysis is weighted through the Analytic Hierarchy Process (AHP) ranking model. To this end, as the problem is formulated as a convex optimization model, and the system provides a low complexity. The MultiObjective Reinforcement Learning (MORL) algorithm with a provable performance guarantee to solve the problem efficiently. The MORL architecture can be successfully trained and allows each UAV to map each observation of the network state to an action to make optimal movement decisions. This network architecture enables the UAVs to balance multiple objectives. Trajectory Optimization, Multi-Objective Reinforcement Algorithm, Bayesian Belief Network, Unmanned Aerial Vehicle (UAV), forest industry, healthcare, and heavy industry [1-6].

In particular, their effective deployment enables them to be useful in the situations where the availability of wireless coverage to ground users is a challenging issue and the traditional cellular networks are sparse or unavailable as for example, in remote or rural areas. a UAV-assisted data network that can provide coverage for the Internet of Things (IoT) in areas such as forest topography for estimated road building and clearance of undesirable tree species. In many circumstances, topography and difficulty of access, harvest, and extraction are determinants of the cost and viability of the intended harvest. There is commercial of UAV operations. This may be a useful and viable option if a manned aircraft provides this function, essentially overseeing multiple UAVs from a manned “Tender” vehicle, managing and reporting the status of all UAVs operations beyond line of sight from the ground. human surveillance.

For example, missions in which line of sight or radio link may be interrupted or other loss of functionality require a “manned” backup capability. The entire mission is monitored to achieve the best UAVs flight trajectories while qualified data transmission is guaranteed across the whole UAV network; Optimization has been conducted to achieve three specific objectives including: 1. Maximizing the quality of data transmitted in support of UAVs network concerning the time limitation range. 2. Maximizing the quality of the data transferred to the cloud based on the significant of the data. 3. Minimizing the imposed risk and hazards during operation.

According to these classifications, a good number of surveys have been published in recent years, which we provide a comprehensive detailed explanation of them in the following sections.

### BRIEF DESCRIPTION OF THE DRAWINGS

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1(a) shows a system for unmanned and manned fleet control.

FIG. 1(b) is an overview of UAVs assisted networks in surveys.

FIG. 1(c) is an overview of the Tender system.

FIGS. 1(d), 1(e) show the UAV system.

FIG. 1(f) is a block diagram of the architecture of a Mission Control Computer.

FIG. 1(g) shows the general architecture of the communication gateway between UAVs and the ground station.

FIG. 2 is a schematic view of the UAV network.

FIG. 3 shows the process of the DRL algorithm.

FIG. 4 is a flow diagram of the MORL algorithm framework.

FIG. 5 is a UAV system failure BBN Model. The BBN architecture is centered on the mishap of concern with the relevant causal risk factor network.

FIG. 6 illustrates Bayesian network describing the inducements of UAV System Failure.

FIG. 7 is the learning process of the MORL algorithm in improving the UAV trajectory over the 3000 episodes. MORL: multi-objective reinforcement learning; UAV: Unmanned Aerial Vehicle.

FIG. 8 is a sum of rewards in different episodes.

FIG. 9 shows UAV optimal trajectories that differ according to objective functions and defined Pareto Front (the figure shows how the algorithm Learn to maximize several rewards (multi objective)).

FIG. 10(a) shows training and validation mean squared error (MSE) measures over epochs on the training and validation sets.

FIG. 10(b) shows training and validation accuracy for MAE.

FIG. 11 is an example of data transfer flow between UAV components with potential types of hardware elements.

FIG. 12 shows an Unmanned Aerial Vehicle (UAV) image processing workflow in relation to image acquisition and field data collection campaigns.

FIG. 13 shows returns from LiDAR pulses that strike vegetation, such as trees or shrubs.

FIG. 14 is Flowchart for a LiDAR distance sensor.

FIG. 15 shows the system layers.

FIG. 16 shows main components of a UAS.

FIG. 17 is a UAS data flow diagram.

FIG. 18 shows the onboard Twin Otter systems.

FIG. 19 shows the structure of the Twin Otter for UAS heterogeneous collaborative system.

FIG. 20 is a flowchart of receiving data for the first two layers of the network.

FIG. 21 is a web graphical control station User Interface.

FIG. 22 is a flowchart of the methodology for tree properties measurements using multi-sensor UAV, photogrammetric and LiDAR data processing and machine learning.

FIG. 23 (left) Orthophoto image resulted from Multispectral image acquired by Mini UAV Mavic over Oakwood cemetery located on the southern side of SUNY ESF campus on Jul. 16, 2021. The image is only RGB, and flight altitude was 60 m. (Middle) Digital Surface Model (DSM) generated using structure from motion (SfM) algorithm applied to the multi-view image of the (left). (Right) Detected tree by automatic segmentation of Ortho and DSM. The height of segments (individual trees) is known from the DSM layer.

### DETAILED DESCRIPTION

In describing the preferred embodiments of the present disclosure illustrated in the drawings, specific terminology is resorted to for the sake of clarity. However, the present disclosure is not intended to be limited to the specific terms so selected, and it is to be understood that each specific term includes all technical equivalents that operate in a similar manner to accomplish a similar purpose.

The system is especially useful in military and forestry applications, and particularly for mountainous terrain. Other applications include surveillance applications in agriculture, forestry, etc.; inspection of electrical transmission and distribution lines; inspection of pipelines; inspection of electric transmission and pipeline rights-of-ways; inspection of primary and secondary roadways; search and rescue; surveillance of affected areas following natural disasters. Accordingly, while a UAV is shown and described, any unmanned vehicle (UV) can be utilized other than an aerial vehicle, and any control vehicle can be utilized other than a tender.

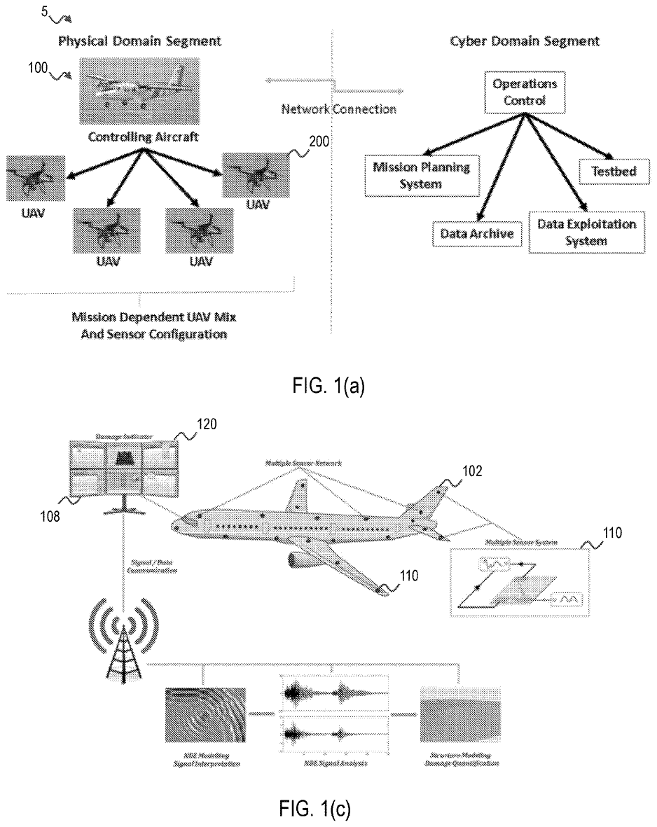

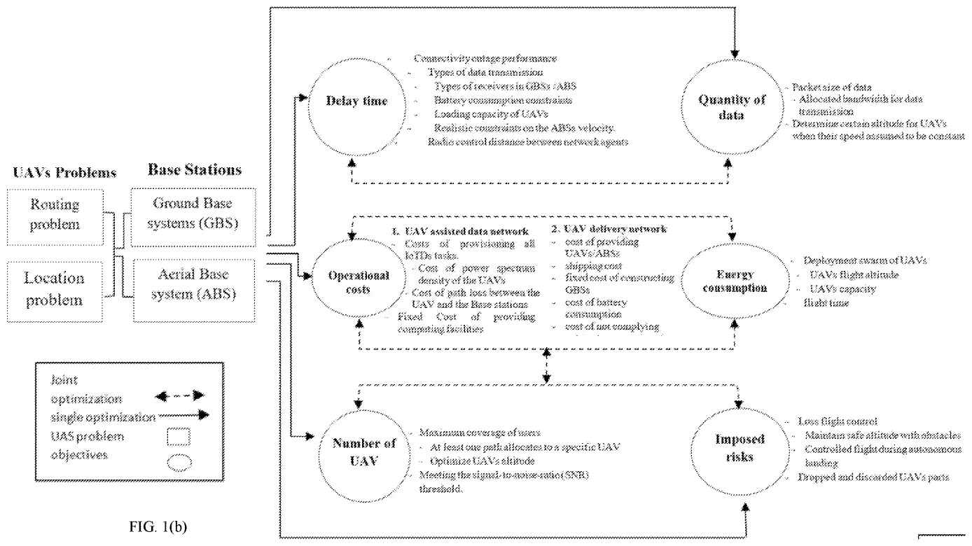

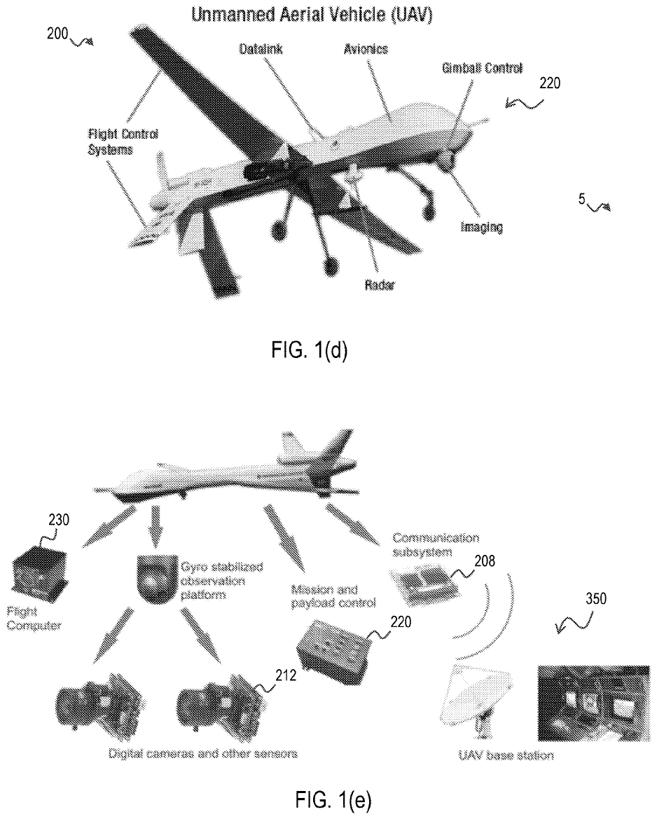

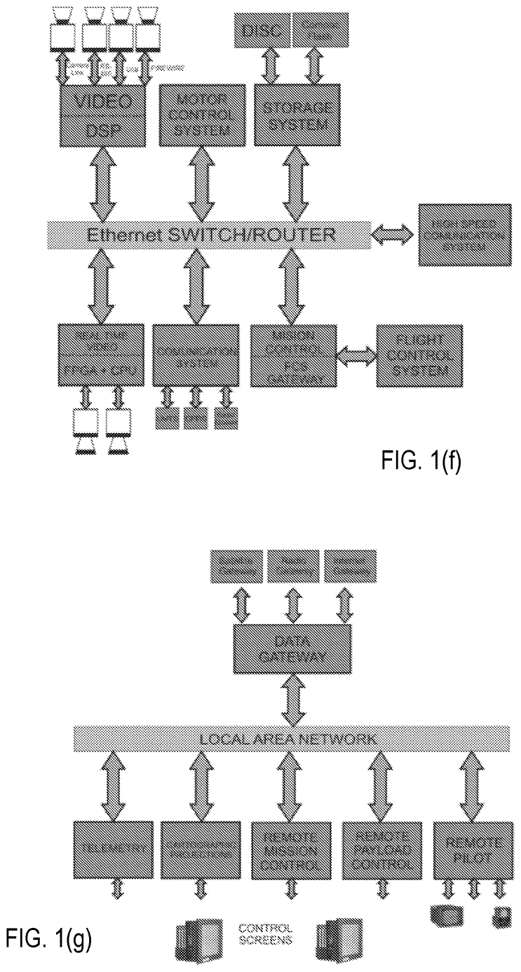

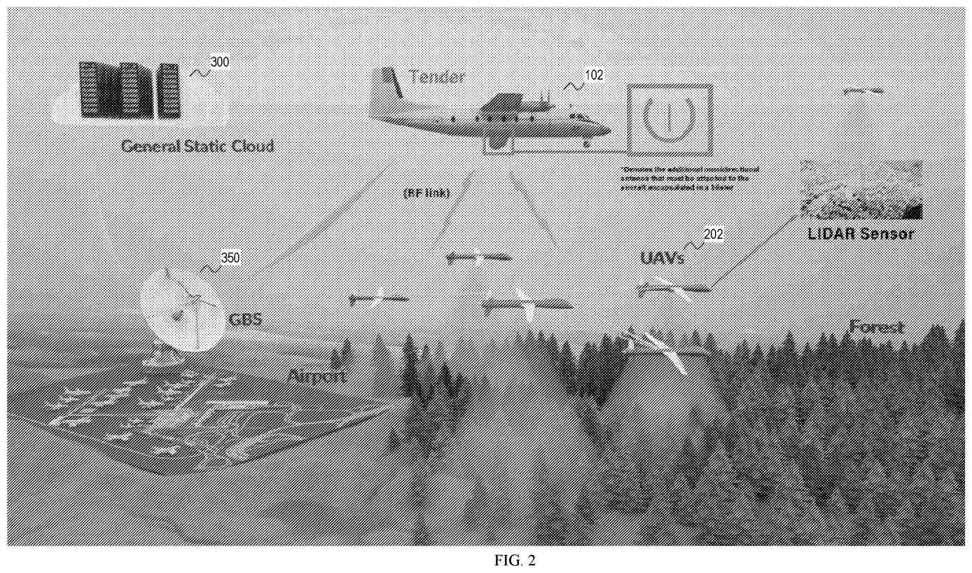

Referring to FIGS. 1(a), 2, the integrated vehicle system 5 is shown. The system includes a central control system or central system 100 located in a manned control vehicle 102 and one or more remote control systems 200 each located in a respective remotely controlled vehicle 202. The integrated vehicle system 5 also includes a static cloud 300 and a Ground Base Station (GBS) 350. Here, the manned control vehicle 102 is shown, for example as a manned “Tender” aerial vehicle. And the remotely controlled vehicles 202 are shown, for example as an unmanned UAV.

Thus, the system 5 provides for the operation of the remote processing device 220 at each of multiple unmanned vehicles (UAV) 202 commanded and supported by a central control processing device 120 at a manned “Tender” air vehicle 102 carrying a pilot and/or flight manager(s). The flight managers in the tender control one or more of the UAVs simultaneously at one time, which enables the flight manager to review data and change the flight operation right away. For example, if a sensor 210 goes bad in one of the UAVs 202, the central controller 120 can override the flight for that UAV. That operation cannot be achieved from the ground, where a UAV operator can only control one UAV at a time, and must wait until the end of the flight to collect data from the UAV.

The “Tender” 102 is equipped to flexibly monitor and manage multiple diverse UAVs over otherwise inaccessible terrain through wireless communication. The architecture enables operations and analysis supported by the means to detect, assess, and accommodate change and hazards on the spot with effective human observation and coordination. optimal trajectories for UAVs to collect data from sensors in a predefined continuous space.

Tender Control System 100 (FIG. 1(c))

Referring to FIG. 1(c), the central control system 100 includes various components including, for example, a control processing device or central controller 120, one or more user input devices 106, a wireless communication device 108, and one or more sensors 110, all of which are located in or at the control vehicle 102. The sensors 110 can include, for example, wireless sensors, Lidar, temperature, soil sensors.

The Tender 102 is equipped with a set of hardware and software that allow UAV operators to communicate with and control a UAV and its payloads, either by setting parameters for autonomous operation or by allowing direct control of the UAV. The Tender 102 has a processing unit 120, which may be an off-the-shelf laptop with an Intel i5 or other common high-performance processor, or a bespoke system based on an embedded computing platform. A wireless datalink subsystem provides remote communication with the UAV system 100. Telemetry data, commands, and sensor data such as video, images and measurements may all need to be transferred between the UAV and the GCS. Communication methods include analogue and digital radio and cellular communications, with operational ranges extending to the hundreds of kilometers.

A wireless datalink communicates with a control module 220 (FIG. 1(d)) on the UAV that adjusts the rotors, throttle and/or flight surfaces (rudder, elevator, and aileron) of the aircraft according to the UAV type and desired mission parameters. The Tender has one or more screens that may feature high-brightness or anti-glare construction for easier operation in bright daylight. It can often be set up so that two operators can work simultaneously-one pilot and one payload operator. The control system may be twin-stick, like common radio-controlled aircraft and small quadcopter controllers, or a HOTAS (Hands on Throttle and Stick) layout, which is an intuitive set-up originating from manned aviation that enables a high degree of flight control and versatility.

The Tender GUI may display map screens, instrument overlays, camera payload feeds, flight parameters and a variety of other information. Control systems built into the Tender may include joysticks for aircraft and/or payload, throttle controllers, as well as keyboard and mouse.

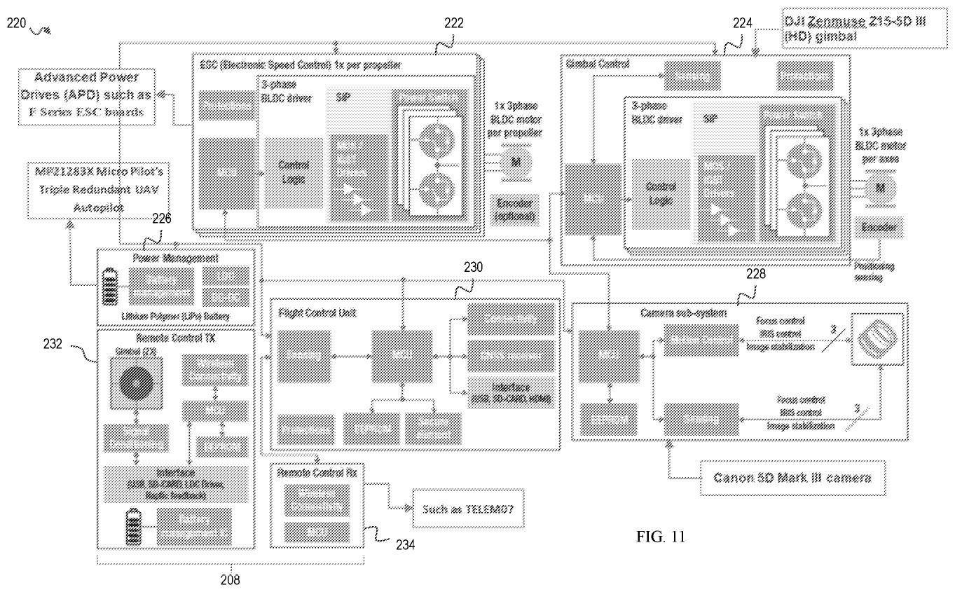

UAV Control System 200 (FIGS. 1(d), 1(e), 11)

Referring to FIGS. 1(d), 1(e), 11, each of the remote control systems 200 includes various components including, for example, a remote processing device 220, one or more user input devices 206, a wireless communication device 208, one or more sensors 210, and imaging device 212, all of which are located in or at the remotely controlled vehicle 202. As illustrated, the remote systems 200 can include technology solutions in the areas of gimbal control, imaging, radar, avionics, data link communications, flight control system, and MEMS based sensor technology for navigation.

The imaging subsystem of a UAV relies on a variety of enabling technologies including sensors 212, computing devices 220, 230, and wireless communications 208 (FIG. 1(e)). A typical platform would be comprised of multiple digital cameras that interface to a geospatial processor. Georeferenced imaging data is distributed through a data networking switch fabric, making system configuration simple, extensible and flexible. The control computer is used to trigger the camera, store and prepare images for transmission while recording data such as camera settings, altitude and position that are attached to images as metadata (Input data). The data is then sent to the UAV ground station via a state-of-the-art wireless network capable of achieving real-time wireless data retrieval of large files. Modern UAVs are capable of capturing and streaming multi-megapixel, large format images and metadata. The imaging control computer is normally decoupled from the flight control computer, with the two computers exchanging information in real time. Flight path and other mission requirements are programmed by engineers into the mission planning software that feeds the autopilot with the data necessary to direct and control the aircraft during the mission (Output data).

The UAV airframe. A simple, lightweight, aerodynamically efficient and stable platform with limited space for avionics, and obviously no space for a pilot. The flight computer. The heart of the UAV. A computer system designed to collect aerodynamic information through a set of sensors (accelerometers, gyros, magnetometers, pressure sensors, GPS, etc.), to automatically direct the flight of an airplane along its flight-plan via several control surfaces present in the airframe.

The payload includes a set of sensors composed of TV cameras, infrared sensors, thermal sensors, etc. to gather information that can be partially processed on-board or transmitted to a base station for further analysis. The mission/payload controller can include a computer system onboard the UAV that controls the sensors' operation is included in the payload. This operation should be performed according to the development of the flight plan as well as the actual mission assigned to the UAV. The base station. A computer system on the ground is designed to monitor the mission development and eventually operate the UAV and its payload.

The communication infrastructure. A mixture of communication mechanisms (radio modems, SATCOM, microwave links, etc.) that guarantees a continuous link between the UAV and the base station. Current UAV technology offers feasible technical solutions for airframes, flight control, communications, and base stations. Communications are also between the UAV and the Tender. However, if civil/commercial applications should be tackled two elements limit the flexibility of the system: human intervention and mission flexibility. Too much human control from the ground station is still required. Flight control computers do not provide additional support beyond basic flight plan definition and operation. Additionally, payload is most times remotely operated with very little automation support. Economic efficiency requires the same UAV to be able to operate in different application domains. This necessity translates into stronger requirements for the mission/payload management subsystems, with increased levels of flexibility and automation.

FIG. 11 is a block diagram of a network for the UAV processor 220 of the UAV system 200. The UAV processor 220 can include, for example, an Electronic Speed Control (ESC) module 222, Gimbal Control module 224, power management module 226, camera sub-system module 228, flight control unit (FCU) or module 230, and a wireless communication device 208 that includes a remote control transmitter module 232 and a remote control receiver module 234. The modules 222-232 can be any suitable module in accordance with standard components. In addition, one or more of the modules 222-232 need not be integrated with the UAV processor 220; instead, the UAV processor 220 can be a separate device that is in wired or wireless communication with one or more of the modules 222-232.

The transmitter module 232 and receiver module 234 can transmit and/or receive signals to/from the ground station 350 and/or the Tender system 100. Thus, the processor 220 can be in wireless communication with the ground station 350 and/or the Tender system 100. For example, the UAV remote control receiver 234 can receive a control signal from the Tender processor 120 via the Tender wireless device 108. Any one or more of the modules 222-230 of the UAV processor 220 can respond in accordance with those received control signals. For example, the UAV FCU 230 can change course for the UAV 202, or the camera module 228 can redirect or refocus the imaging devices (e.g., camera, LIDAR or infrared detector).

In a LiDAR system, light is emitted from a rapidly firing laser. This light travels to the ground and reflects off of things like buildings and tree branches, which is input data. The LiDAR system measures the time it takes for emitted light to travel to the ground and back. That time is used to calculate distance traveled. Distance traveled is then converted to elevation. (These measurements are made using the key components of a LiDAR system including a GPS that identifies the X, Y, Z location of the light energy (called a waveform) and an Internal Measurement Unit (IMU) that provides the orientation of the plane in the sky, which is output data.

UAV flight dynamics are highly variable and non-linear, and so maintaining attitude and stability may require continuous computation and readjustment of the aircraft's flight systems. This Synchronization requires flight control software and hardware elements on the ground form part of a Ground Control Station (GCS) and may include a modem and datalink for communicating with the UAV.

UAV autopilots allow fixed-wing and rotary drones to automatically takeoff and land, execute pre-programmed flight plans and follow waypoints, as well as hover in place (for rotary platforms) or circle a particular location (for fixed-wing platforms). They may also utilize UAV payloads and gimbals such as cameras and sensors.

UAV autopilots may gather information from an Air Data System (static and dynamic pressure), GNSS receiver or Attitude and Heading Reference System/AHRS (roll, pitch and yaw data), which is Input data. A flight control computer (FCC) uses this data to guide the UAV to its next waypoint, activating the required servos, actuators and other control systems, and steering the aircraft in the required direction. The FCC may also operate UAV payloads and communicate with the GCS (Output data).

In one embodiment, a radio-frequency (RF) transmission can be used to transmit and receive information to and from the UAV. These transmissions can include location, remaining flight time, distance and location to target, distance to the pilot, location of the pilot, payload information, airspeed, altitude, and many other parameters, which are Input data.

Various frequencies are used in the data link system. These frequencies are used are based on UAV brand as well as functionality of the UAV. For example, DJI systems use 2.4 Ghz for UAV control and 5 Ghz for video transmission. This setup gives the user approximately 4 miles of range. However, if using 900 Mhz for UAV control and 1.3 Ghz for video, a distance of 20+ miles can be achieved (FIG. 7). The Data Link portion of the UAS platform also happens to be the most vulnerable in detection and countermeasures. All data link systems in a UAS must comply with FCC Part 15 and Part 97.

### System Architecture

The hardware architecture of the Mission Control Computer, which is located at the tender, is built as a set of embedded microprocessors connected by a local area network (LAN), i.e. it is a purely distributed and therefore scalable architecture (see FIG. 1(f)). Even though this is a simple scheme it offers a number of benefits that motivates its selection in our application domain.

The high level of modularity of a LAN architecture offers extreme flexibility to select the actual type of processor to be used in each submodule. Different processors can be used according to functional requirements, and they can be scaled according to the computational needs of the application. System modules can be wakened up online when required at specific points of the mission development. Modules can be added (even hot-plugged) if new requirements appear. Development simplicity is the main advantage of this architecture. By using techniques inspired by Internet communication protocols, computational requirements can be organized as services that are offered to all possible clients connected to the network.

In a UAV, several communication links may be available, for instance RF-links, SATCOM links, or wireless links. However, not all links may be available at the same time, and moreover the cost of using each link could be completely different. Depending on the flight stage and application, some of the links may be more appropriate than others. Therefore, in a flexible architecture it should be possible to dynamically choose the most convenient or reliable network link.

The present system 200 includes a communication manager (or gateway) that monitors all communication links and routes the traffic between the UAV and the ground base station 350 through one or more communication links. Network capabilities, their link quality (bandwidth and latency), the required throughput, and the usage cost (both economical and power requirements) should be taken into account. The gateway should have enough intelligence to select the appropriate routing decision in a real-time and autonomous way.

One of the key elements of this communication gateway is the fact that it provides a homogenization mechanism to hide the actual infrastructure used at any time. A data router at the entry point of the base station and another at the Mission Computer redirects all traffic between the air and the ground segments through the best available link. FIG. 1(g) depicts a one suitable architecture of the ground station and the gateway that provides connectivity to the UAV 202 in flight. The gateway concentrates all traffic from the available links and re-injects it into the LAN at the ground station 350.

From the whole perspective, the system and subsystems implement the following sequence:
1. The supervisory observer in the piloted aircraft 102 provides, each robot UAV with a target location identified from observation, aerial photographs, or other data sources. The supervisory pilot/observer may visually monitor the progress of each robot UAV through the completion of the following stages, verifying de-confliction of all flight paths. The user enters commands through the user input device on the central processor 120. The command signal is transmitted from the wireless communication device 108 to the UAV processor 220, via the UAV wireless device 208. The UAV processor 220 then controls the UAV flight controller to control flight of the UAV in accordance with the command signal from the central processor 120. Operation is simultaneously and in real time controlling operation of all of the plurality of UAVs during flight of the Tender 102 and the plurality of UAVs 202.
2. The UAV navigates to the designated position over the target grove at a moderate altitude well clear of the terrain, takes a LIDAR image of the grove, and selects a tree crown using predetermined criteria, or may request guidance from the supervisor.
3. The UAV repositions over the selected tree crown and descends to a safe altitude above it, navigating based on LIDAR imaging of the grove and targeted tree.
4. The UAV takes a detailed LIDAR image (enhanced by a broad-spectrum photo image, et al.) and performs an automated quality check and, if the image and other data pass the check criteria, transmits the image to the human observer for a visual quality assessment, etc.
5. If satisfactory, the onboard observer passes the image to the ground station for archiving and further processing and onward transmittal & and redirects the UAV to the next target. If not, the observer identifies corrective action.

Other operational requirements include that the controlling aircraft flies at a preferred Above Ground Level (AGL) altitude of >1,000 ft. Drones must fly at an AGL altitude of <=300 ft. Drones must be able to physically carry sensors and supporting electronics to perform forest inventories. Remote control/data transfer between aircraft and drones must be on an FCC approved frequency. Drones must have sufficient power to operate sensors, supporting electronics, and remote control/data transfer communications components. Communication frequency used for remote control/data transfer for the drones must not interfere with the operation of existing aircraft instruments. Communication frequency used for remote control/data transfer for the drones must not interfere with the operation of forest inventory sensors and supporting electronics. Aircraft must be able to pass Electromagnetic Interference (EMI)/Electromagnetic Compatibility (EMC) certification after integration of remote control/data transfer communication components for drones. Drone pilot(s) must always maintain Visual Line of Sight (VLOS) with drones.

### Ground Station 350

The system also includes a mobile ground station 350, as a depository for data and to accommodate human review and intervention and system sustainment. This functional architecture also facilitates “cloud” robotics sharing of information storage/retrieval and computational burdens across the three components of the system of systems, with remote computing and backup cloud data archiving. of systems robot/human collaboration concept. The baseline system of systems are configured for daylight operations with good visibility, and has three sub-system classes:
At least one ground support station acquiring, verifying, storing, processing and exporting the data acquired to remote archival storage and further analysis (GCS). This data stream are duplicated in the command aircraft for quality control. The ground support station are located at an airfield base supporting the FLM/UAS operation, including spares and maintenance stocks and tooling.
One manned command aircraft managing the data acquisition UAS, including task allocation, high level operational planning, surveillance, and system health management. This subsystem commands the UAS missions and deployment, flight paths and sensor operation, validating acquired data against requirements. It maintains visual and operational surveillance of the data acquisition UAS to assure safe operation and mission success, while acting as a data communications relay between the three classes of subsystems.
Multiple data acquisition UAS fitted with a variety of sensor payloads: cameras, various radars (including LIDAR) and other necessary sensors, plus autonomous flight navigation, sensor management and raw data transmission to the ground control station. The integrated sensor and data acquisition system are implemented via an innovative UAS optical fiber data network, which also supports UAS and sub-system health management to assure operational reliability & safety. The UAS is capable of “nap of the earth” flight in proximity to the forest canopy for high resolution imaging.

The system and subsystems are expected to implement the following sequence:
1. The supervisory observer in the piloted aircraft provides each robot UAV a target location identified from observation, an aerial photograph, or other records. The supervisory pilot/observer may visually monitor the progress of each robot UAV through completion of the following stages, verifying de-confliction of all flight paths.
2. The UAV navigates to the designated position over the target grove at a moderate altitude well clear of the terrain, takes a LIDAR image of the grove and selects a tree crown using predetermined criteria, or may request guidance from the supervisor.
3. The UAV repositions over the selected tree crown and descends to a safe altitude above it, navigating based on LIDAR imaging of the grove and targeted tree.
4. The UAV takes a detail LIDAR image (enhanced by a broad-spectrum photo image, et al) and performs an automated quality check and, if the image and other data passes the check criteria, transmits the image to the human observer for a visual quality assessment, etc.
5. If satisfactory, the onboard observer passes the image to the ground station for archiving and further processing and onward transmittal & and redirects the UAV to the next target. If not, the observer identifies corrective action.

Throughout the process, the observer monitors automated status pages for each UAV to assure readiness for scheduled activities. These flag individual UAV incapacity, fuel load adequacy, and any need to redirect UAS of impending collision. Initial investigation focused on the unmanned aircraft system and its sensor suite capabilities and suitability, as the greatest project risk.

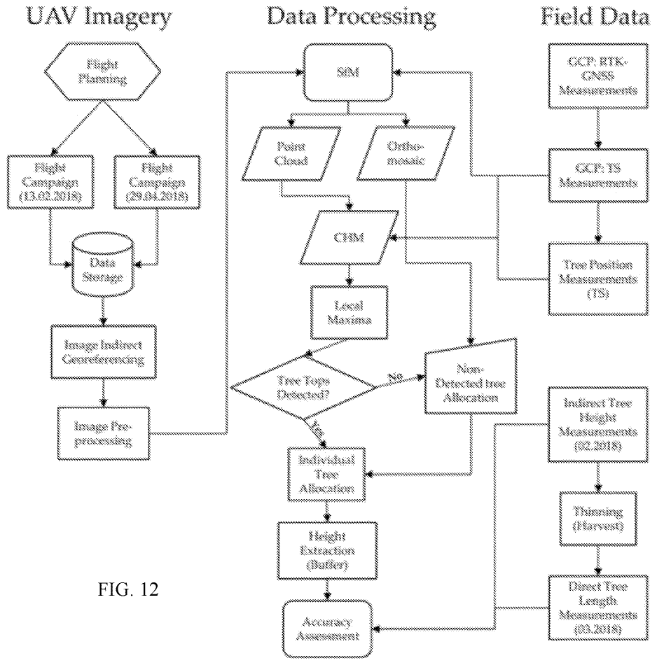

### UAV Cloud Management (FIG. 12)

In one configuration of cloud components, we consider here a private cloud type with components similar to the platform components of OpenStack. A potential cloud structure would include hardware, operating system, platform manager, cluster manager, block-based storage (BBS), and file-based storage (FBS). A potential Cloud Computing framework can be implemented in real Arduino hardware and requester software.

FIG. 12 shows how a data workflow in a UAV cloud management platform could be configured. The workflow can be performed by the UAV processor 220, and can include UAV imagery, data processing, and field data.

### System for Fleet Coordination and Control of Manned and Unmanned Aerial Vehicles

The operation of multiple unmanned vehicles (UAV) commanded and supported by a manned “Tender” air vehicle carrying a pilot and flight manager(s). The “Tender” is equipped to flexibly and economically monitor and manage multiple diverse UAVs over otherwise inaccessible terrain through wireless communication. The architecture enables operations and analysis supported by the means to detect, assess and accommodate change and hazards on the spot with effective human observation and coordination. Further, this system finds the optimal trajectories for UAVs to collect data from sensors in a predefined continuous space. Path-planning problem for a cooperative, and a diverse swarm of UAVs tasked with optimizing multiple objectives simultaneously with the goal of maximizing accumulated data within a given flight time within cloud data processing constraints as well as minimizing the probable imposed risk during UAVs mission. That includes Mission Planning, Mission Retasking, Mission Reconfiguration, Automated Mission Plan Validation, Verification and Safety Assurance, Automated Mission Planning, and Demonstration of Autonomous Behavior.

The risk assessment model determines risk indicators using an integrated SORA-BBN (the Specific Operation Risk Assessment-Bayesian Belief Network) approach while its resultant analysis is weighted through the Analytic Hierarchy Process (AHP) ranking model. To this end, as the problem is formulated as a convex optimization model, and a low complexity MultiObjective Reinforcement Learning (MORL) algorithm is used with a provable performance guarantee to solve the problem efficiently. The MORL architecture can be successfully trained and allows each UAV to map each observation of the network state to an action to make optimal movement decisions. This network architecture enables the UAVs to balance multiple objectives including, for example: Trajectory Optimization, Multi-Objective Reinforcement Algorithm, Bayesian Belief Network, Unmanned Aerial Vehicle (UAV), forest industry, healthcare, and heavy industry [1-6].

In particular, the deployment enables them to be useful in the situations where the availability of wireless coverage to ground users is a challenging issue and the traditional cellular networks are sparse or unavailable as for example, in remote or rural areas. The system focuses on the uses of UAVs in the forest industry. In the forests product industry, since usually forest topography needs to be investigated therefore, it is essential to have a UAV-assisted data network that can provide coverage for the Internet of Things (IoT) in areas such as forest topography for estimated road building and clearance of undesirable tree species. In many circumstances, topography and difficulty of access, harvest, and extraction are determinants of the cost and viability of the intended harvest.

The system can be used as a commercial UAV operation. This is a useful and viable for a manned aircraft to provide this function, essentially overseeing multiple UAVs from a manned “Tender” vehicle, managing and reporting the status of all UAVs operations beyond line of sight from the ground. human surveillance. For example, missions in which line of sight or radio link may be interrupted or other loss of functionality require a “manned” backup capability. The entire mission is monitored to achieve the best UAVs flight trajectories while qualified data transmission is guaranteed across the whole UAV network; Optimization has been conducted to achieve three specific objectives including: 1. Maximizing the quality of data transmitted in support of UAVs network concerning the time limitation range. 2. Maximizing the quality of the data transferred to the cloud based on the significant of the data. 3. Minimizing the imposed risk and hazards during operation.

### Forestry

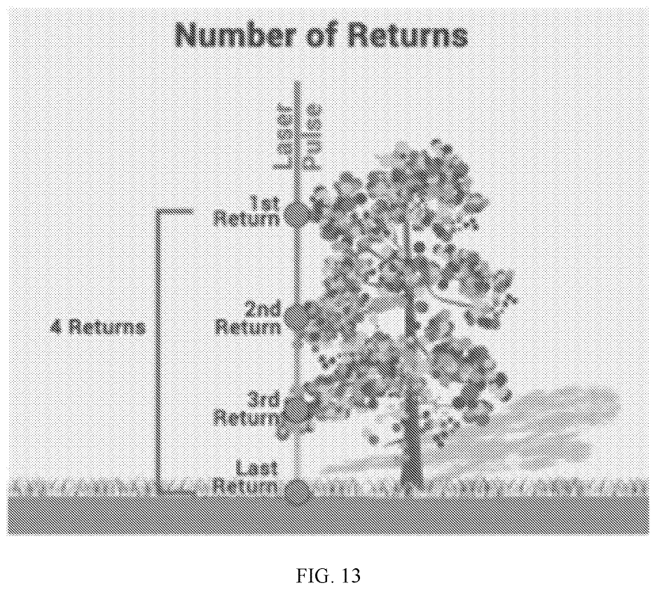

In an example of a UAV network for a forestry right-of-way surveillance application, we considered a Geiger LiDAR unit embedded at nadir point. As the UAV travels in the air, it sends over 160,000 pulses per second. For every second, each 1-meter pixel gets about 15 pulses. This type of LiDAR can cover much wider footprints compared to traditional LiDAR. It can scan widths of 16,000 ft. For example, considering a UAV data network in forestry or right-of-way surveillance, LiDAR pulses can hit bare earth or short vegetation. Then, a significant amount of the pulse penetrates the forest canopy just like sunlight. According to FIG. 13, the laser pulse goes downwards. When light hits different parts of the forest, one gets a “return number”.

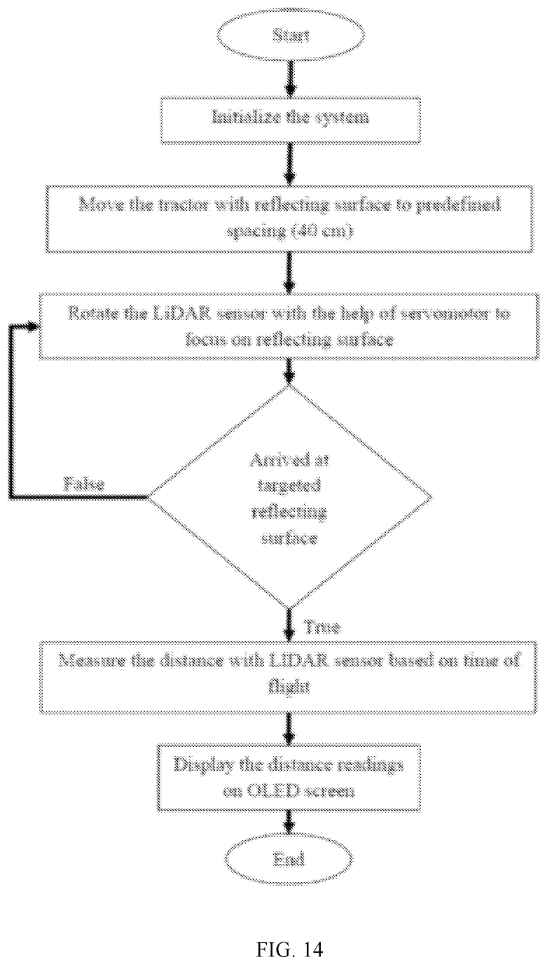

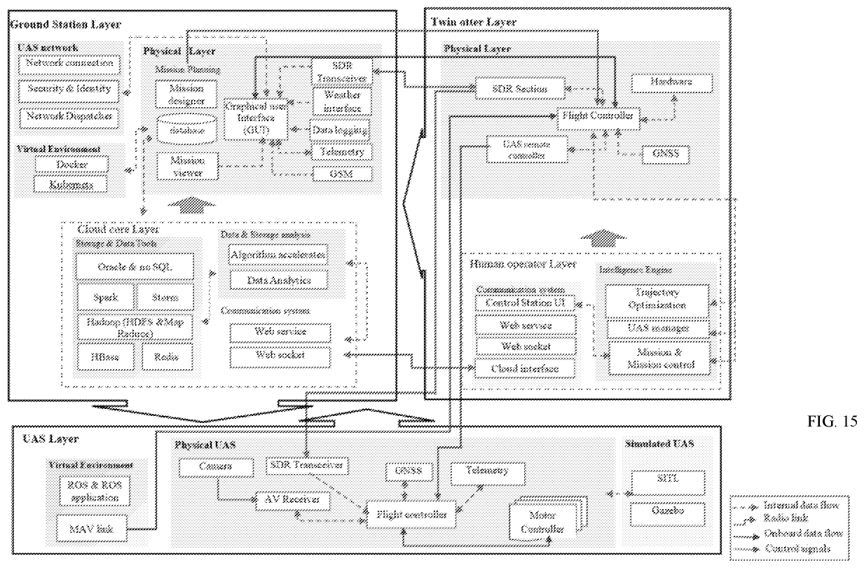

In this way, LiDAR systems can record information starting from the top of the canopy through the canopy all the way to the ground. This makes LiDAR valuable for interpreting forest and vegetation structure and shape of the trees or vegetation. A data transmission network for LIDAR can be drawn as a flowchart as shown in FIG. 14.

Path-planning is provided for a cooperative, and a diverse swarm of UAVs 202 tasked with optimizing multiple objectives simultaneously with the goal of maximizing accumulated data within a given flight time within cloud data processing constraints as well as minimizing the probable imposed risk during UAVs mission.

The risk assessment model determines risk indicators using an integrated SORA-BBN (the Specific Operation Risk Assessment-Bayesian Belief Network) approach while its resultant analysis is weighted through the Analytic Hierarchy Process (AHP) ranking model.

Multi-Objective Reinforcement Learning (MORL) algorithm allows each UAV to map each observation of the network and make the best decision.

Optimization of data collection to achieve three specific objectives: 1. Maximizing the quality of data transmitted in support of UAVs network concerning the time limitation range. 2. Maximizing the quality of the data transferred to the cloud based on the significant of the data. 3. Minimizing the imposed risk and hazards during operation.

This disclosure provides a multi-objective model where three sub-systems of the air-to-ground communication system are examined to guarantee the safety and success of their mission. These sub-systems include UAVs, GBSs, and tenders. One (or more) manned aircraft, i.e., tenders, which monitor and control the function of a group of UAVs in obtaining data, manages the communication. In this network, tenders are tasked to determine whether UAVs should be utilized or not, schedule the trajectory, determine the operations of IoT sensors, and validate the data obtained for the preset requirements. In the simulated model, UAVs are routed for the optimization of two objectives: an increase in the quality of transmitted data and risk reduction on any possible transmission path. This operation introduces a combination of automated and manual processes in a three-echelon supply chain. The routing operation of UAVs in the entire chain has been designed based on data transmission flow in the network of UAVs on the first echelon and the last echelon for GBSs while tenders are on the middle echelon, tasked to validate and ensure the estimated quality of data transmitted from the previous echelon. The communication structure of the network in this model is backed up and managed using wireless communication (radio or possibly other communication media) in remote and inaccessible areas such as tree farms. It is noteworthy that this geographical texture is common in Australia and even the Southeastern United States.

From the whole perspective, the system and subsystems are expected to implement the following operations, which can be in sequence. First, the supervisory observer in the piloted aircraft 102 provides each robot UAV 202 a target location identified from observation, an aerial photograph, or other records. The supervisory pilot/observer may visually monitor the progress of each robot UAV through completion of the following stages, verifying de-confliction of all flight paths.

Second, the UAV navigates to the designated position over the target grove at a moderate altitude well clear of the terrain, takes a LIDAR image of the grove and selects a tree crown using predetermined criteria, or may request guidance from the supervisor.

Third, the UAV repositions over the selected tree crown and descends to a safe altitude above it, navigating based on LIDAR imaging of the grove and targeted tree.

Fourth, the UAV takes a detail LIDAR image (enhanced by a broad-spectrum photo image, et al) and performs an automated quality check and, if the image and other data passes the check criteria, transmits the image to the human observer for a visual quality assessment, etc.

And fifth, if satisfactory, the onboard observer passes the image to the ground station for archiving and further processing and onward transmittal & and redirects the UAV to the next target. If not, the observer identifies corrective action.

In the structure of the UAV data network, the “Tender” architecture facilitates operations and analysis on the fly, enabled by means to detect, assess and accommodate change and hazards, on the spot with human oversight. The human pilot(s) in the “Tender” air vehicle will typically fly higher than a UAV's prescribed maximum altitude above the terrain, e.g. 10,000 ft., managing the UAV operations and limiting hazards. The “Tender” also includes radio (or optical) communication and command databases within the UAV “flock” allowing where maneuvering is necessary.

### Mathematical Model

The risk assessment model determines risk indicators using an integrated SORA-BBN (the Specific Operation Risk Assessment-Bayesian Belief Network) approach while its resultant analysis is weighted through the Analytic Hierarchy Process (AHP) ranking model. To this end, as the problem is formulated as a convex optimization model, and the system provides a low complexity MultiObjective Reinforcement Learning (MORL) algorithm with a provable performance guarantee to solve the problem efficiently. The MORL architecture can be successfully trained and allows each UAV to map each observation of the network state to an action to make optimal movement decisions

Function of quality of data to send/receive. Factors determining the quality of transmitted data, which are links between the numbers of data transmission flows, analyze the rate of input data and the number of active sensors in the network in devices connected to the network given the time constraint for transmission. Each determining factor of the data transmission optimization has been defined in each part of the first objective function. In this objective function, however, two time constraints have also been considered. In the first constraint, hard time windows, data is transmitted within a specific timeframe, according to which data should not be transmitted later than αₙ and sooner than bₙ in the coordinates, otherwise the objective function is penalized. In the second constraint, considering the soft time windows, the data should not be transmitted sooner than Eₙ and later than Lₙ in the [Eₙ, Lₙ] timeframe. In this stage, the data transmission system in the network of UAVs is penalized if it deviates from the timeframe of the objective function. Further, the type of transmitted data could affect its quality.

In the network 5 of UAVs 202, a communication system 5 with N UAVs and M manned aircrafts (tenders) 102 have been taken into account. The UAVs are assumed to fly at a constant velocity W and at a constant height H (meter). In this network, tenders are flying as a set of T={T₁, T₂, T₃, . . . , Tₘ}, on a 3D plane with the length and width of L₁ and L₂, and at a constant height H. Thus, location coordinates for each tender(s) T_{M} is defined as Tₘ=(aₘ, bₘ, Hₘ). UAVs move from a hypothetical starting point L₀ to a destination L_{D} at a varying height throughout the trajectory. The origin coordinates L₀=(x₀, y₀, Hₙ) of the starting point of the UAVs' mission and the destination coordinates L_{D}={X_{D}, Y_{D}, Hₙ} of their ending point have been illustrated in a 3D space using a Cartesian coordinate system. If the coordinates of UAVs at t are Uₙ(t)=(Xₙ(t), yₙ(t), Hₙ(t)), the horizontal distance from UAVs to tender(s) at t is defined as below:

$${d}_{m} = \sqrt{{‖ {U}_{n} ( t ) - {T}_{m} ‖}^{2}} \qquad ( 1 )$$

Since the mission of UAVs 202 is imaging data collection, each UAV can have a maximum of B_{N} Bits of capacity data to send or upload to tenders. The sharing system follows the Time-Division Multiple Access (TDMA) protocol in uploading and collecting data, in which case each user transmits in succession using their own time slot t. This communication has been defined within the C_{N} range, which determines a reliable level of communication systems in the network. The communication channel between the interconnected components of the network is supported based on the FCC frequency, which is dependent on the real-time location of UAVs. Accordingly, the channel width created between UAVs at t and in their real-time location can be obtained using the following equation:

$${h}_{nm} ( c ) = {β}_{0} {{d}_{nm} ( c )}^{- α} = \frac{{β}_{0}}{{( {‖ {U}_{n} ( t ) - {T}_{m} ‖}^{2} )}^{\frac{α}{2}}} \qquad ( 2 )$$

where β₀ indicates the extent of its communication level in the associated channel considering the dₘₙ distance, the distance from Tender m to UAV n. In this Equation, α≥2 and denotes the maximum extent of miscommunication at t. Further, in order for the data transmission to not surpass the specified value r₀, it is assumed that there is maximum flow between UAVs and tenders at any moment of t which is called signal to-interference ratio (SIR). Therefore, for any moment within the t∈[0,T] range, I(t) indicates how many communications are sent to Tender m at any moment, which is expressed as below:

$$I ( t ) = {T}_{m} = {min}_{{T}_{m} ϵ D} ‖ {T}_{m} - {U}_{n} ( l ) ‖ \qquad ( 3 )$$

The reception rate C (t) is obtained as expressed below:

$$C ( t ) = {log}_{2} ( 1 + \frac{{P}_{n} {\vert {h}_{nm} ( t ) \vert}^{2}}{{σ}^{2}} ) = log ( 1 + \frac{{γ}_{0}}{{[ {( {a}_{m} - {x}_{n} ( t ) )}^{2} + {( {b}_{m} - {y}_{n} ( t ) )}^{2} + {( {H}_{m} - {H}_{n} ( t ) )}^{2} ]}^{α}} ) \qquad ( 4 )$$

In this Equation, Pₙ denotes the transmission power by the UAV n, σ² denotes the average energy of the Additive white Gaussian noise (AWGN) in each UAV. This value could also be replaced by

$${γ}_{0} = \frac{{PB}_{0}}{{σ}^{2}} ,$$

which indicates the ratio of the communication signal to the existing noise considering the Signal-to-noise ratio (SNR). To ensure the quality of transmitted data, the transmission rate of the received data by each tender m, rₘ(t) must be able to exceed the minimum targeting rate r₀. Thus, if UAV n is selected for data transmission, its reception rate in tender m is:

$$R ( t ) = \{ \begin{matrix}C ( t ) , if ( 3 ) and C ( t ) > {r}_{0} \\ 0 , otherwise\end{matrix} \qquad ( 5 )$$

Considering the introduced concepts, first objective function in the first loop of the supply chain with the aim of maximizing the quality of data collection is expressed as:

$$Max {\int }_{0}^{T} R ( t ) d ( t ) \qquad ( 6 )$$

$$s . t . ( {x}_{n} ( t ) , {y}_{n} ( t ) , {h}_{n} ( t ) ) ∈ ψ \qquad ( 7 )$$

$${\int }_{t {ϵτ}_{n}} R ( t ) d ( t ) \leq {B}_{n} \qquad ( 8 )$$

$$\sqrt{{( {x}_{D} - x ( 0 ) )}^{2} + {( {y}_{D} - y ( 0 ) )}^{2}} \leq V \cdot UT \qquad ( 9 )$$

This is despite the fact that τₙ is the total time tenders spend on collecting data from Uₙ. Constraint 7 reveals that UAVs can only fly within the feasible region ψ. Constraint 8 demonstrates that Uₙ have at least managed to transmit Bₙ Bits of data to tenders. This constraint shows that as the number of UAVs increases, the tenders collect data from more UAVs. If Bₙ→∞, the mission of the tenders is to collect data from the closest UAVs while travelling the shortest route. Constraint 9 shows that the problem is feasible at velocity V and time T and it travels the minimum distance Dₘᵢₙ considering the constant velocity of UAVs (V) and their time of flying (UT).

The flight space in the feasible region u is defined as a N₁×N₂ grid layout with small squares. It is assumed that each UAV connects with Tₘ when it is positioned in the square associated with each tender m. In this mode, the size of each square can be obtained by dividing the total flight time by the time slots:

$$τ = \frac{UT}{N} .$$

According to the definition of the time windows in another part of the objective function, each one determines during what window of time the data will be transmitted. If Eₙₘ is the earliest allowed time to transmit data from UAV n to tender m while Lₙₘ is the latest allowed time to transmit data from UAV n to tender m, the model will be penalized if the mission is performed out of this framework, whether it be later or earlier. Thus, the objective function is rewritten as follows:

$$Max {\int }_{0}^{T} ( R ( t ) - {W}_{2} \cdot {\sum }_{n ∈ {U}_{n}} \sum {E}_{n} - {W}_{3} \cdot {\sum }_{n ∈ {U}_{n}} \sum {L}_{n} ) d ( t ) \qquad ( 10 )$$

$${E}_{n} \geq ( {E}_{n} - {S}_{n} ) , ∀ n ∈ {U}_{n} \qquad ( 11 )$$

$${L}_{n} \geq ( {S}_{n} - {L}_{n} ) , ∀ n ∈ {U}_{n} \qquad ( 12 )$$

$${S}_{n} + \frac{{d}_{m}}{{v}_{n}} - M \cdot ( 1 - {d}_{m} ) \leq {S}_{m} , ∀ n ∈ {U}_{n} , ∀ m ∈ {T}_{m} \qquad ( 13 )$$

$${S}_{n} + \frac{{d}_{m}}{{v}_{n}} + M \cdot ( 1 - {d}_{m} ) \geq {S}_{m} , ∀ n ∈ {U}_{n} , ∀ m ∈ {T}_{m} \qquad ( 14 )$$

$${a}_{n} \leq {S}_{n} \leq {b}_{n} , ∀ n ∈ {U}_{n} , ∀ m ∈ {T}_{m} \qquad ( 15 )$$

$$UT \geq {S}_{n} + \frac{{d}_{m}}{{v}_{n}} - M \cdot ( 1 - {d}_{m} ) , ∀ n ∈ {U}_{n ,} , ∀ m ∈ {T}_{m} \qquad ( 16 )$$

$${\sum }_{n ∈ {U}_{n}} {\sum }_{m ϵ {T}_{m}} {S}_{n} \cdot {d}_{m} \leq {FT}_{m} , ∀ n ∈ {U}_{n} , ∀ m ∈ {T}_{m} \qquad ( 17 )$$

### Function of Cloud Data Archiving

Cloud data archiving is automated. In the second objective function, the routing for UAVs is optimized when the data are stored in GBS 350 (FIG. 2) on the last echelon of the chain using cloud data at the cloud 300 archiving after being analyzed and validated in the tenders. In this method of data storage, the data are allocated to a cluster based on the position of the node collected through the UAVs. Based on the analyzed region, the region is divided into cluster parts P_{z}={P₁, P₂, P₃, . . . , P_{z}}. For each part P, Sᵢ is considered the probable point whose data has been collected through the UAVs and can have various positions Sᵢ{xᵢ, yᵢ}. If m denotes the number of data collection types, each Uₙ collects a set of data type Lₘ={L₁, L₂, . . . , Lₘ}. To illustrate the link between the data type and the clusters, a significant coefficient φ(Sᵢₘ, P_{z}) is defined. In this mode, if the data is illustrated with volume (Bₘ) and a set of priorities Wₘ={w₁, w₂, w₃, . . . , wₘ}, the probable point will have a significant correlation with cluster z:

$$φ ( {S}_{im} , {P}_{z} ) \{ \begin{matrix}1 , if \frac{{B}_{m}}{{( {‖ ( {x}_{i} - {x}_{n} ) + ( {y}_{i} - {y}_{n} ) ‖}^{2} + {H}^{2} )}^{\frac{α}{2}}} > {r}_{0} \\ 0 , otherwise\end{matrix} \qquad ( 16 )$$

Therefore, by analyzing significant correlations between P_{z} and Sᵢ a matrix Δ^{m×n} is generated with rows and columns indicating probable points and clusters, respectively. In this matrix, if the sum of row and column f with Sr(f) equals Sc(f), for all Sᵢ in cluster a, we have Sr(a)>1.

To obtain the objective function components, its comprising factors are defined based on the following concepts.

If the number of significant Sᵢₘ in cluster a (αₐ(i)) to the total is calculated, the value of the significant coefficient of cluster a τₐ(i)) is expressed as:

$${τ}_{a} ( i ) = \frac{{α}_{a} ( i )}{{β}_{a} ( i )} \qquad ( 17 )$$

To determine the integrity of data derived from Sᵢ in each cluster, if ϵₐₙ(i) and εₐₙ (i) indicate the amount of data packet received and the total Uₙ from Sᵢ in each cluster s, respectively, the obtained ϑₐₙ(i) rate to these two parameters is as follows:

$${ϑ}_{n} ( i ) = \frac{{ϵ}_{an} ( i )}{{ε}_{an} ( i )} \qquad ( 18 )$$

where from the sum of them, the integrity of the total received data from each Sᵢ by each cluster will be obtained from the following:

$$ℓ ( i ) = \frac{{\sum }_{a = 1 , n ∈ {U}_{n}}^{z} \sum {ϵ}_{an} ( i )}{{\sum }_{a = 1 , n ∈ {U}_{n}}^{z} \sum {ε}_{an} ( i )} \qquad ( 19 )$$

However, to determine the quality of the data while creating integrity in the obtained data:

$${F}_{s} = \frac{{\sum }_{a ∈ z} {α}_{a} ( i ) \cdot {ω}_{i}}{{D}_{f}} \qquad ( 20 )$$

Therefore, for the maximum amount of quality data received, there must be balance in the three factors, the level of significance of Sᵢ, their processing priority (ωᵢ), and the travelled distance D_{f}:

$$\begin{matrix}Max {F}_{s} \\ S . t . ,\end{matrix} \qquad ( 21 )$$

$$( {α}_{a} ( i ) , {β}_{α} ( i ) , {D}_{f} ) > 0 \qquad ( 22 )$$

### The Function of Risk

Considering each stage of communication flows in the network, identifying the probable errors and risks in conducting the mission provides an opportunity for the system to reprioritize in case an error occurs and it is capable of reconfiguration based on the collected data. Both in the designs of human-approved processes in tenders and in automated processes of UAVs 202 during data collection and transmission, this function can improve the efficiency of the UAV network. It analyzes how and under what circumstances the automated behavior of the UAV network is safe and reliable. Thus, the risks are first identified according to the SORA methodology for the first step of the Bayesian Belief Network. The foundation concept of BBN is built on Bayes' theorem. In this approach, probability distributions for the random variables (nodes) as well as the type of relationships between the random variables (edges) are determined subjectively. [35].

Afterward, for the quantitative calculation of the comprising risk criteria in each classification, the Eurkut et al method was employed. In this method, each risk criterion is estimated using the Equation below:

$${S}_{nm} = {\sum }_{( n ∈ {U}_{n} , m ∈ {T}_{m} )} {\breve{p}}_{nm} {l}_{n} \qquad ( 23 )$$

where p̌ₙₘ is the risk occurrence probability at a time when a communication channel is created between the nth UAV and the mth tender. Here, lₙ denotes the consequences of risk occurrence that can be estimated as the cost of providing a proper communication ground to transmit data by the nth UAV. This amount is weighed by experts and with the use of historical data.

The significance of each component is determined by the decision makers' perspectives; however, it should be remembered that each of the risk factors stated has a distinct level of significance that is examined in each scenario in the classification of BBN. Then, the linguistic variables of experts are classified in proportionate range of the adopted degrees of the assessment scale that gives p̌ₙₘ Table 1 shows the likelihood of events expressed by the frequency of their occurrence.

TABLE 1
Likelihood of events expressed by the frequency of its occurrence

| Rating Category | Description | Value |
|---|---|---|
| Certain | Expected to occur regularly under | 10 |
| | normal circumstances | |
| Very likely | Expected to occur at some time | 7.5 |
| Possible | May occur at some time | 5 |
| Unlikely | Not likely to occur in normal | 2.5 |
| | circumstances | |
| Rare | Could happen but probably never will | 0 |

In the next step to achieve lₙ, Analytic Hierarchy Process (AHP) method is applied. Accordingly, the risk of each action (Sₙₘ) is calculated based on the instruction stated as follows.

The AHP technique is used to convert these factures to a unique facture. As a result, the path risk (Sₙₘ) is determined using the following commands: (1) Identifying and weighing efficacious risk indicators for n UAV (assessed by the BBN); (2) Employing average to specify the weights of each facture; (3) Calculating the risk of each route by applying the weights (In) assigned to the rout risk variables through the equation; (4) Designing a risk matrix for the communication channel from UAV n to Tender m; (5) The second goal's function is to choose the best trajectory for n UAV with the minimum risk via the present model.

The factors must be defined before the optimization of the model, so they are calculated according to the related various features. AHP is a multi-criterion decision-making (MCDM) method for ranking several alternatives with respect to their various criteria. The AHP is applicable when the weight of criteria is unknown. According to the AHP methodology, each possible route can be ranked by the risks measured in weights. They are estimated by individual experts' experiences and recorded historical data.

By considering all the mentioned description the third objective function can be stated as equation (24).

$${Z}_{3} = Min Log ( 1 + {\sum }_{n ∈ {U}_{n} , m ∈ {T}_{m} , t ∈ T} \frac{{S}_{nm}}{{( {a}_{m} - {x}_{n} ( t ) )}^{2} + {( {b}_{m} - {y}_{n} ( t ) )}^{2} + {( {H}_{m} - {H}_{n} ( t ) )}^{2}} ) \qquad ( 24 )$$

$$S . T .$$

$${S}_{nm} \leq μ {\sum }_{n ∈ U} {d}_{nm} , ∀ n ∈ U , m ∈ {T}_{m} \qquad ( 25 )$$

$${S}_{mn} \leq μ {\sum }_{n ∈ U} {d}_{nm} , ∀ n ∈ U , m ∈ {T}_{m} \qquad ( 26 )$$

By taking advantage of the model, the risk value can be considerably reduced with only a slight increase in the classical objective function value. At present, risk analysis is necessary to carry out operations that go beyond the Bayesian belief networks. It focuses on assigning to UAVs-operation different classifications of risk by determining The tool essentially combines a broad range of factors potentially contributing to the hazards and risks of UAV flight tests. Bayesian Belief Networks (BBN), is a tool to depict and quantitatively evaluate relation and influences between causal factors affecting probabilistic outcomes of interest, applying Bayes theorem to propagate the causal probabilities across the resultant network. We intend to explore the use of this technique as a safety assurance and assessment technique for an entire mission. Then, to assess the consequences parameter lₙ, we exploit AHP method through passing the key steps as discussed above.

### Solution Representation (Methodology)

The deep reinforcement learning (DRL) method is used to determine the validity and efficiency of the presented model. This algorithm was developed according to the model for optimization and the simultaneous realization of three objectives. The presented algorithm is an approach based on multi-step DRL, where, in every step, the model trains and optimizes the UAV flight trajectory according to the fitness pattern introduced in the objective function by defining an action-value set. In this algorithm, the UAVs act as agents aiming to learn the best trajectory strategy. In every step of the algorithm, the agents adjust their behavior or policy based on the awareness of their current state, their actions, and the reward they earn per unit time. In fact, through its action and the resulting reward, the agent trains itself on its next action and shifts to a new state [36]. Specifically, each subsequent action of the agent is carried out via a balance between exploration and exploitation in the state environment so that it can determine the best existing strategy [37]. Exploration is defined as finding more about the environment. Exploitation is defined as using known information in order to maximize the rewards.

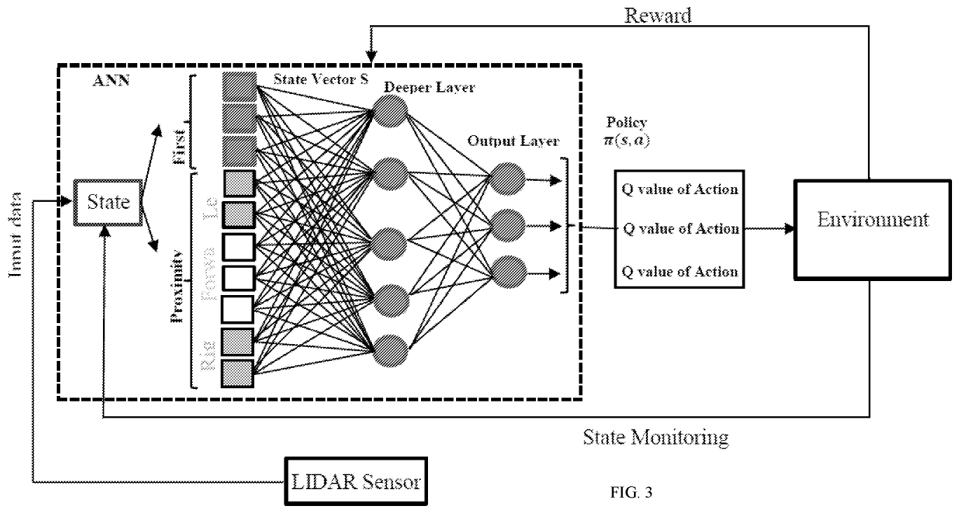

This strategy is based on the maximum reward accumulated from one action in interaction with the environment considered for that action [40]. In DRL, the best state is selected by constructing the function Q. In fact, the reward for the best state (q) is estimated as a result of the relationship between the deep layers in a neural network. FIG. 3 displays the algorithm's process considering the application of dense deep layers in multilayer perceptron (MLP) artificial neural networks (ANNs).

### The Implementation of the DRL Algorithm

Reinforcement learning elements. In this algorithm, a set of states s∈S and a set of actions a∈A are defined for each agent at time t. Consequently, a set of rewards r E R in a future time t is estimated as a result of every action a due the state s. Specifically, if the environment under study in the presented model is assumed to be a grid plate n×n, the UAVs must set off from an origin and arrive at a destination in a confined space. Therefore, the UAV mission is converted to episodic tasks. The movement of each UAV is defined in the set A={up, down, left, right}. In other words, the UAV can undergo six movements in the x, y, and z directions in each state, such as {+x, −x, +y, −y, +z, −z}.

Reward and value functions. In the reinforcement learning (RL) algorithm, a reward is assigned to every action at time t. The reward R (t) in fact specifies a degree of inherent desirability of a given state in interaction with the environment and its value is estimated according to the optimized objective functions. If the order of rewards received by the agent after the tth step is expressed as a sequence rₜ₊₁, rₜ₊₂, rₜ₊₃, the final reward for each state in the subsequent action (s′(t+1)) is equal to all the rewards given to actions related to that state (a(t+1)). Its value depends on how much that action brings the agent closer to the pre-specified terminal point. This amount represents the value of each state (Rₜ) [38]. The given reward is evaluated based on the defined objective functions. In the present system, the more the volume of collected data is maximized and the less the risk involved in the selection of UAV trajectories, the higher the reward awarded to that action. Hence, the value function is written as follows:

$${R}_{t} = {r}_{t + 1} + γ {r}_{t + 2} + {γ}_{t + 3}^{2} + … = {\sum }_{k = 0}^{∞} {γ}^{k} {r}_{t + k + 1} \qquad ( 27 )$$

The value of the discount rate (γ) determines the weight of each reward and is itself determined by the extent to which the performed action a due to the state s contributes to the gaining the reward [37]. This factor has a value between 0 and 1. Specifically, the closer gamma is to 1, the smaller the discount will be and the higher the probability of long-term rewards will be. In contrast, if gamma is closer to 0, the discount is higher, and the agents pay more attention to short-term rewards [38].

### Policy-Based Deep Reinforcement Learning Algorithm

In DRL, the value function is estimated using the deep layers in the ANN and is then used to estimate the state-action, i.e., the Q function. The value of a state is considered to represent its desirability. The subsequent state adopted by the agent is highly dependent on the performance its has undertaken [39], and this shows the behavior or policy of the agent (π). πₜ(s, a)=p is a probability function that indicates every action a in every state s occurs with the probability p. Moreover, the value of the state taken by each agent via adopting the policy π is denoted by V_{π}(s) and is equal to the following:

$${V}_{π} ( s ) = {E}_{π} [ {\sum }_{K = 0}^{T} ( {R}_{t} \vert {S}_{t} = s ) ] \qquad ( 28 )$$

Accordingly, if the value function of the action a of the state s′ at time t+1 is measured based on the values of the actions performed at time t, then its value is determined using the following equation:

$${Q}_{π} ( s , a ) = {E}_{π} [ {\sum }_{K = 0}^{T} ( {R}_{t} \vert {S}_{t} = s , {a}_{t} = a ) ] \qquad ( 29 )$$

This function is known as the Q function and can somehow predict the quality of prospective actions based on the existing state-action pairs. The higher the number of layers of Q values considered, the higher the accuracy of the prediction. In each step, if Policy π at time t recommends Action a for State s, Policy π′ for State s at time t+1 will be optimal if it is larger than V_{π}(s). In other words,

$${Q}_{π} ( s , α ( {s}^{′} ) ) > {V}_{π} ( s ) \qquad ( 30 )$$

Hence, the optimal policy is determined using the following relationship:

$${π}^{′} ( s ) = ( arg {max}_{a ∈ A ( s )} {Q}_{s , a} \vert {Q}_{s , a} = Q ( s , a ) + α [ R ( s , a , {s}^{′} ) + γ {max}_{{a}^{′} ∈ A ( {k}^{′} )} Q ( {s}^{′} , {a}^{′} ) - Q ( s , a ) ] ) \qquad ( 31 )$$

### Multi-Objective Reinforcement Learning Algorithm

Three objective functions were defined in the model in the present system, the first two of which move in the same direction in order to perform a maximization, and the third moves opposite the other two in order to perform a minimization. Therefore, instead of a set of scalar rewards for each policy, there will be a reward vector that is assigned to policies each of which optimizes one objective [41]. The multi-objective reinforcement learning (MORL) algorithm makes use of the concept of a Pareto set to correctly evaluate the existing policy signals. This disclosure employs multi-policy models of the MORL algorithm. In a Pareto front, these models provide a set of optimal solutions, which consider the individual preferences of each objective while demonstrating how the objective share their optimality data. Based on this model, the reward vector is defined as follows: \vec{r}(t)=(r₁, r₂, r₃)

$${\vec{r}}_{n} ( t ) = \{ \begin{matrix}\begin{matrix}- 1 , & if - The agent cannot reach the first target in the first step at time t \\ - 1 \times ( {D}_{f} - {D}_{{f}^{′}} ) & if - The agent cannot be in the specified cluster region in the first step at time t \\ - 2 & if - The agent cannot optimize the third objective function in the first time at time t\end{matrix} \\ 0 , otherwise\end{matrix} \qquad ( 32 )$$

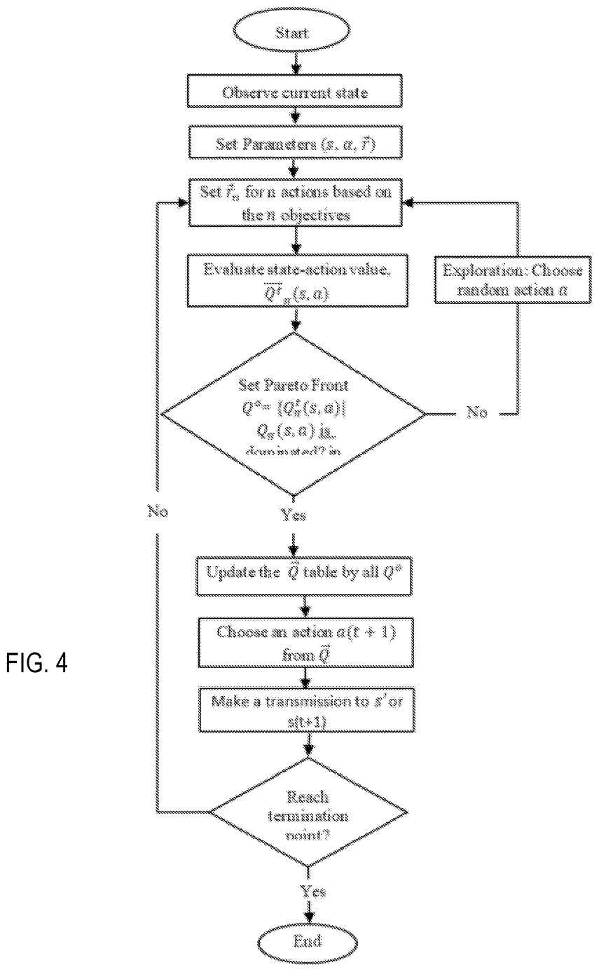

The MORL algorithm selects a vector of Q values that are non-dominated based on the Pareto concept. In other words, instead of using the maximum expected reward, as is common in classical RL, this method employs a set of expected rewards that are maximum for some of the priorities provided by the weight vector \vec{w}. This technique was derived from the Convex Hull Value Iteration (CHVI) algorithm. Accordingly, the Bellman equation may be rewritten as follows [42]: The steps in the MORL algorithm based on Eq. (33) are as displayed in FIG. 4.

$$Q ( s , a ) = E ( \vec{r} ( s , a ) + γ POS {⋃}_{{a}^{′}} ( {Q}^{0} \dot{( s , {a}^{′} )} \vert s , a ) ) if \vec{r} ( s , a ) = \vec{w} \cdot \vec{r} ( s , a ) \qquad ( 33 )$$

The implementation of the developed algorithm can also be observed in table 2 (Algorithm 1).

TABLE 2
The pseudo code of the MORL algorithm
Algorithm 1- Proposed iterative MORL algorithm

X_MAX = 2000.0
Y_MAX = 2000.0 # The area region in meters
Z_MAX = 1000.0
MAX_VALS = np.array([[X_MAX,
Y_MAX, Z_MAX]])
# UAV flying destination in meter
DESTINATION = np.array([[1400, 1600, 5]],
dtype = “float32”)
# considered as reach destination if UAV reaches the
vicinity within DIST_TOLERANCE meters
DIST_TOLERANCE = 30
replay_memory1 = [ ]
DISCOUNT = 1
REPLAY_MEMORY_SIZE = 100_000
# How many last steps to keep for model training
MIN_REPLAY_MEMORY_SIZE = 5_000 # Minimum number of
steps in a memory to start training
MINIBATCH_SIZE = 32 # How many steps (samples) to use
for training
UPDATE_TARGET_EVERY = 5 # Terminal states (end of
episodes)
MAX_STEP = 200 # maximum number of time steps per episode
MODEL_NAME = ‘512_256_128_128’ #
MIN_REWARD = −1000 # For model save
nSTEP = 30

### Bayesian Belief Network

With the advent of UAV-based data transfer networks, serious challenges arose in flight safety during their operation as much as their application in various fields advanced. Specifically, any unexpected change in UAV behavior during flight can result in serious and irreparable damage. One of the goals of the introduced model is to improve the safety of UAVs flying over dense groups of trees. Hence, one must ensure that UAVs experience a controllable and safe flight throughout their mission. This section demonstrates how each of the input variables defined in the model, including p̌ₙₘ and lₙ, are obtained via the qualitative Bayesian belief network (BBN) technique and then weighted using an analytic hierarchy process (AHP). After the BBN is formulated, the obtained qualitative indexes are first classified and detected using the Specific Operations Risk Assessment (SORA) standard in the causal risk factor (CRF) identification step.

BBN Framework Compatible with the Established UAV Network

The BBN method is a graphical model of probabilities that represents a system as a set of stochastic variables along with the level of interdependence between them. The variables are the nodes of this network, and the links between them are represented using arcs. The presence of an arc between two nodes indicates causal relationships between them, while its absence shows their mutual independence. The nodes representing the CRFs are the parent nodes, and their subset nodes are known as the child nodes. However, a node can be a parent and a child node at the same time. In the present system, a risk model based on BBN and the architectural components of the semi-autonomous UAV network is presented with three sub-layers in its structure. The UAV's mission is controlled in all three sub-layers manually and automatically. The three sub-layers are as follows: (1) Remotely piloted aircraft in command/UAV, (2) ground base station, and (3) a Twin Otter aircraft piloted by human to control and monitor UAVs performance manually. SORA classifies the probable risks in each of the three levels in a UAV-assisted mission from three perspectives: (1) UAV system failure, (2) ground risk classes, and (3) air risk classes [44,45]. Accordingly, in the first step, the CRFs of the presented system are detected and extracted in matrix form by considering the system dimensions as the columns and the risk levels as the rows of the matrix.

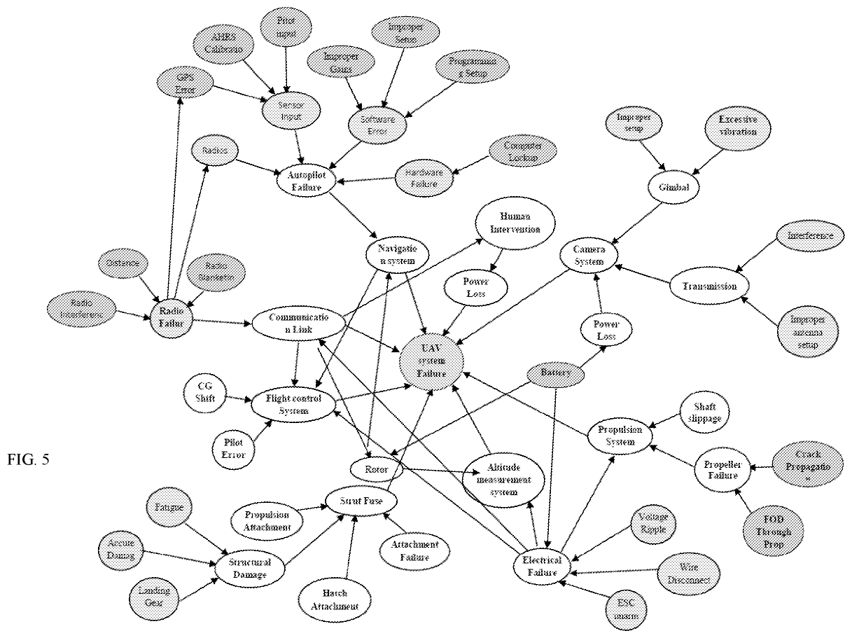

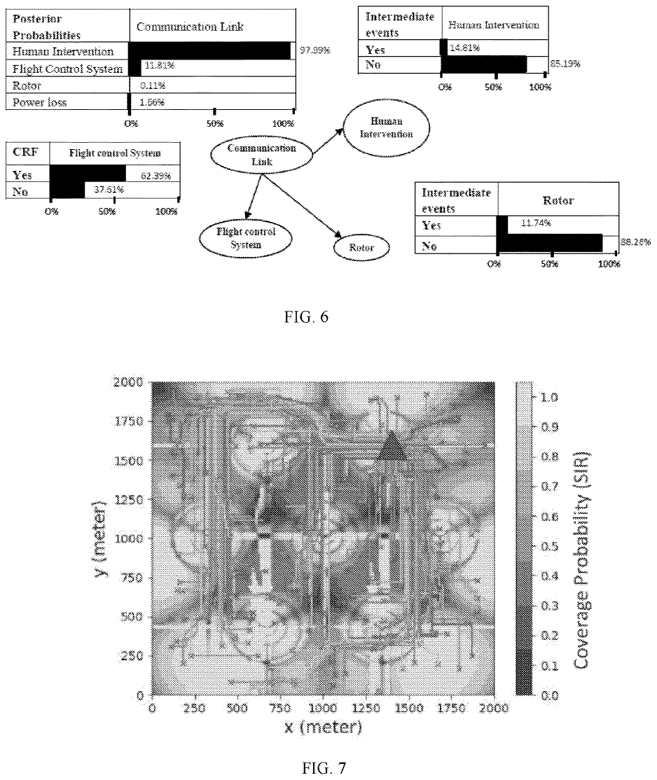

FIG. 5 shows how the CRFs and their dependencies are displayed for the UAV system risk level. In this work, the BBN is obtained and plotted through the following steps:
1. The probable and critical events and the consequences of their occurrence during UAV missions are determined and selected.
2. For each detected event, its main CRFs and the state of their occurrence (their extent of their effect on the event) are identified.
3. The CRFs are prioritized based on their importance, reflecting their level of dependence. In this step, the dependence graph is plotted with direct causal links without a return path between every two nodes.
4. In this step, the BNN is plotted according to a conditional probability table (CPT). This table is obtained considering the result expected from the occurrence of the CRFs and an accumulation of the experts' opinions.
5. The solution for eliminating and modifying each probable risk and its possible effect on improving the safety of the system is evaluated proportionally to each CRF.
6. Then, at every risk level in the BNN graph, the total risk level is measured according to the calculated mishap probability of each CRF. FIG. 6 depicts an example of this sensitivity analysis [7,46].

Any unexpected change in UAV behavior during flight can result in serious and irreparable damage. One of the goals of the introduced model is to improve the safety of UAVs flying over potential hazards or potential obstructed visibility, such as dense groups of trees. Hence, the system 5 must ensure that UAVs experience a controllable and safe flight throughout their mission. When considering each stage of communication flow in the network, identifying probable errors and risks in conducting the mission provides an opportunity for the system to reprioritize in case an error occurs and it is capable of reconfiguration based on the collected data. Both in the designs of human-approved processes in tenders and in automated processes of UAVs during data collection and transmission, this function can improve the efficiency of the UAV network. It analyzes how and under what circumstances the automated behavior of the UAV network is safe and reliable. Thus, in this study, the risks are first identified according to the SORA methodology for the first step of the Bayesian Belief Network. In this approach, probability distributions for the random variables (nodes) as well as the type of relationships between the random variables (edges) are determined subjectively. CRF variables for another function in UAV system failure are shown in FIG. 6.

Based on the recorded results of the statistical analysis on the operational data and the literature [7,43,45,487,48], the BNN graph of UAV system failure is displayed as in FIG. 5. Subsequently, the strength of the links plotted between the nodes must be determined to obtained the CPT. In this state, if the system components, i.e., the variables, are in the form of the set N={n₁, . . . , nᵣ}, the output of the CPT is as follows:

$$P ( {n}_{1} , … , {n}_{r} ) = {∐}_{q = 1}^{r} P ( {n}_{q} \vert {π}_{q} ) \qquad ( 34 )$$

P(n_{q}|π_{q}) represents the occurrence probability of each node n_{q} providing a set of π_{q} parents exists for them. This conditional probability depends on the type of relationship between the nodes and their parent nodes [50]. FIG. 6 displays this difference based on the flight control system intermediate event from the BBN graph of FIG. 5 along with a computed example from the CPT. The conditional probabilities in this table were determined using Eq. (34) and (35):

$$p ( {n}_{q} \vert {π}_{q} ) = \frac{p ( {π}_{q} \vert {n}_{q} ) \cdot p ( {n}_{q} )}{p ( {π}_{q} )} \qquad ( 35 )$$

This process entails a wide cognitive load for the experts in this domain when there is a large number of parents since, in this case, the conditional probability of each parent variable is directly obtained from the probability distribution of the number of child nodes of that parent. On the other hand, each conditional probability is obtained from the knowledge of a domain expert via their personal experience and represents their subjective probability. This knowledge is as rich as their experiences and is diverse as their biases [49].

Accordingly, in every episode defined in the action of the UAVs in the predefined plane ψ, the risk index p̌ₙₘ from the origin point (UAV) n in every episode up to a destination point (Tender) m depends on the average of the possible CRFs determined by the experts in the candidate range of the subsequent actions.

Every CRFs evaluated by the experts based on limited areas of search space. In fact, feasible region y divided by the N₁×N₂ squares, which is the size of a time slot, hence, the experts choose a set of these squares as a specific area, at this point, and they express their opinion on the probable risk index for these predefined areas. Experts' opinions are checked in terms of not having conflicting evaluations by evaluating the weights of each identified risk index using an analytic hierarchy process (AHP). Expert opinions may change from one period to another and are only valid for a certain period.

### Computational Result

This section simulates a small-scale problem involving the presented UAV network in order to validate the model. The model parameters and the algorithm are assumed as in Table 3.

TABLE 3
parameters of the model

| | | |
|---|---|---|
| Parameters | Symbol | value |

Model Parameters

| | | |
|---|---|---|
| Velocity, Altitude, flight | vₘ, hₘ, FTₘ | 180 kt, 5000 ft, |
| time of Tender | | 100 s |
| Gravity acceleration | g | 9.8 m²/s |
| Weight, velocity, Altitude | wₙ. vₙ, hₙ | 100 k, (3-100)^{m}/s, |
| range of UAV | | (300-1000) ft. |
| RF link parameters | β₀, r₀, Pₙ, σ² | −5 db, 900 MHz, |
| | | 0.01 w, 10⁻¹¹w |

MORL Algorithm Parameters

| | | |
|---|---|---|
| Greedy selection, discounting | ϵ, γ, α | 0.1, 0.98 ,0.5 |
| factor, Learning rate | | |
| feasible region | N₁ × N₂ | 2000 × 2000 |
| Initial location of UAV | L₀ = (x₀, y₀, Hₙ) | {1400, 1600, 300} |
| Final location of UAV | L_{D} = {X_{D}, Y_{D}, Hₙ} | {1750, 1750, 300} |

The MORL algorithm developed in the 2000×2000 grid optimizes the trajectory of a UAV according to the definition of the 3000 Episode. Every UAV must fly at a specific altitude from the trees. The model was solved by considering the following general assumptions. Controlling aircraft flies at a preferred Above Ground Level (AGL) altitude of >1,000 ft. Drones must fly at an AGL altitude of <=300 ft. Drones must be able to physically carry sensors and supporting electronics to perform forest inventories. Remote control/data transfer between aircraft and drones must be on an FCC approved frequency. Drones must have sufficient power to operate sensors, supporting electronics, and remote control/data transfer communications components. Communication frequency used for remote control/data transfer for the drones must not interfere with the operation of existing aircraft instruments. Communication frequency used for remote control/data transfer for the drones must not interfere with the operation of forest inventory sensors and supporting electronics. Aircraft must be able to pass Electromagnetic Interference (EMI)/Electromagnetic Compatibility. (EMC) certification. After integration of remote control/data transfer communication components for drones. Note: UAV pilot(s) must always maintain Visual Line of Sight (VLOS) with drones.

FIG. 7 represents the convergence and the optimal UAV trajectory in each training layer in the model. In this state, the position of a UAV and its next action is defined in such a way as to maximize the collected data. The regions with warmer colors represent those where the UAV has the best possibility for establishing an RF link and, hence, covers a larger space in the trees. In this routing, the minimum distance up to the destination for presence confirmation was 30 m. The UAV trajectory shows the extent to which the choice of the best position depends on the SIR. Assuming the UAV to be higher than 300 ft, the most UAV motion is observed approximately in positions between the points (500,750) and (800,1750) and the points (1000,250) and (1850,1900). The UAV attempts to provide the most coverage over areas with both high and low SIR probability. As such, the data are collected from all the specified area and will not be restricted to a specific ones. On the other hand, through back and forth movements during its mission, the UAV tends to cover 400000 (m²2000×2000) possible states of action on the map, such that after every subsequent action, the UAV attempts to cover all the map during the time range defined for each state (0.5 the length of a time step per second) in addition to repeating its action in the previous range.

In this model, a ground base station was considered, in which the data flow is stored and processed in the form of clouding after being controlled and verified in the tenders. FIG. 8 displays the sum of the rewards awarded and the correct data collected based on the Q-learning method. The size of the correct data collected by the UAVs follows an increasing average trend similar to that of the rewards collected. This shows that the defined reward did not perform correctly since, as defined by Eq. 32, the closer the reward to zero, the more accurate the action of the UAV. In addition, the sum of the calculated rewards is larger than the collected data. This is because virtual data were introduced as reward for the model simulation.

As mentioned in the explanation for the MORL algorithm, in multi-objective learning algorithms, an exploration occurs in the space of the three objective functions in order to obtain a Pareto front of the optimal solutions. Specifically, three rewards are awarded to each action from the three objective functions, and the best action in each state is determined according to a vector set of rewards and, hence, their corresponding policies. In other words, if each policy is represented as πₘ, objective functions and their policies are defined by Eq. 36.

$${max}_{π} F ( π ) = {max}_{π} {f}_{1} ( π ) , … , {f}_{m} ( π ) {f}_{1} ( π ) \qquad ( 36 )$$

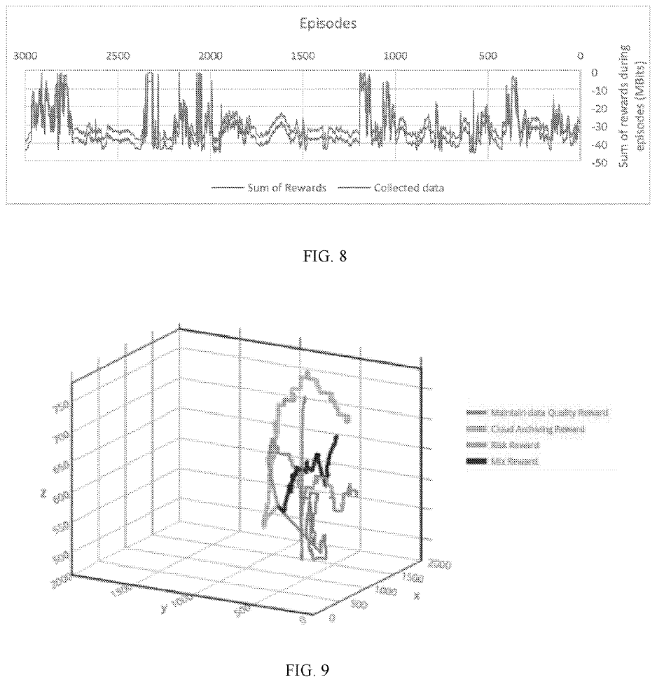

Then, π₁ is superior to π₂ only when fⱼ(π₁)≥fⱼ(π₂) for all j=1, . . . , m and fₗ(π₁)≥fₗ(π₂) and at least one of the values l=1, . . . , m. In this case, a policy π_{*}∈β will be a Pareto policy when it is not dominated by any policy in β and is better than the rest in at least one of those policies. FIG. 9 shows that the optimal trajectory of the UAV with respect to the reward of each related objective function. Moreover, the Pareto front of all three objective functions was obtained by combining their rewards and plotted alongside them. As seen in the figure, the black path is plotted in the direction of the other three paths as their estimate, and the algorithm was able to learn how to maximize the sum of the rewards received for all three objective functions.

### Training Behavior

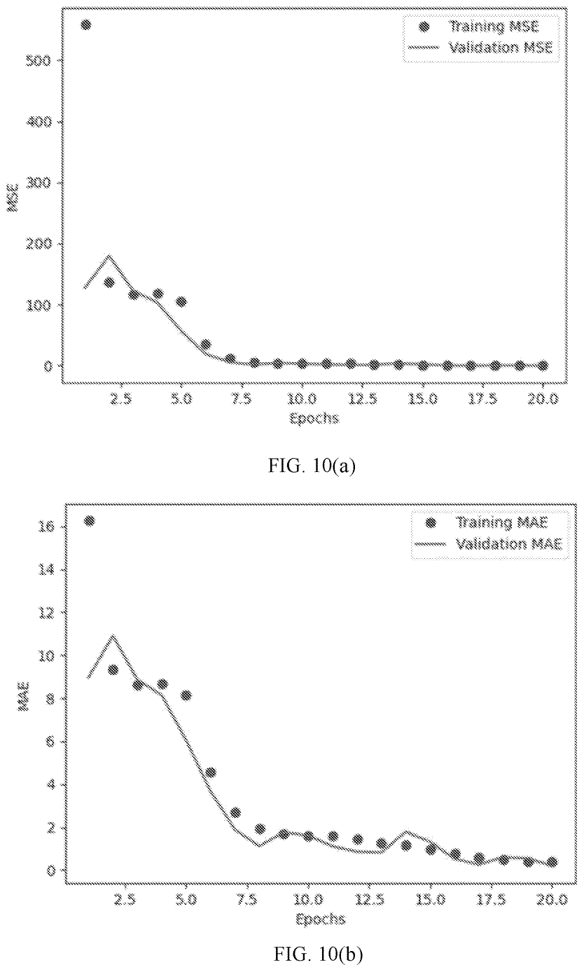

FIG. 10(a) shows the training behavior of a MODRL algorithm based on the mean squared error (MSE) criterion. This criterion evaluates the algorithm by defining training and validation sets along with a penalty for the model's prediction error. As seen in the figure, the validation MSE graph converged in the beginning with a small distance from the training set curve although the two graphs ultimately match as the epoch number increases. This indicates that the algorithm minimized its errors in its final executions. This is because not only did it follow a decreasing trend and reached close to zero but also it fully matched the trained sets almost after Epoch 6. Similarly, the MAE index converged in a decreasing manner with the increase in the epoch number. However, it merely expresses the average difference between the existing data with the predicted and the real data.

### Cloud Layers (FIG. 15)

In one embodiment of the present disclosure, an innovative and novel approach is provided utilizing cloud computing as a potential solution for the design of air-ground collaborative systems involving UAS. One perspective indicates that incorporating a cloud-based control system for UAS could provide supplementary storage and computational capabilities. Additionally, by utilizing a cloud server with internet connectivity, it becomes possible to control and communicate with UAS from any location at any time, without being limited by communication range constraints. On the contrary, the network architecture introduces the possibility of monitoring one or multiple UAS through the utilization of a crewed aircraft operated as a “tender.” The “Tender” vehicle suite, comprising air-to-air UAS control and software, can be effectively integrated with established UAS “ground-to-air” management systems. Specifically, this innovation enhances the coherence and dependability of the data communication networks within the system. The architecture of the Tender aircraft vehicle offers the potential to streamline analysis operations, allowing for real-time detection, evaluation, and adaptation of opportunities and hazards through various radio-based methods:
1. On the flip side, the present disclosure constructs a hierarchical model that elucidates the data connections between layers, wherein multiple UAs serve as layer 1, receiving commands and support from one or more crewed “Tenders” operating as layer 2. Tenders are aerial vehicles where the presence of uncertainty and risk necessitates the involvement of human operators in the decision-making process. Afterward, in the ultimate layer (Mission Retasking).
2. Mission Reconfiguration.
3. Automated Mission Plan Validation, Verification and Safety Assurance.
4. Automated Mission Planning.
5. Demonstration of Autonomous Behavior.

The received data is supervised and operated in areas that are not within the direct line of sight (LOS) from ground stations (GS). During this phase, the cloud layer has been conceptualized as a sublayer within the primary ground station layer which offers additional storage and computational capabilities. The design of these hierarchical layers draws inspiration from the principles of the IoT and cloud robotics. The architecture, similar to IoT, encompasses a network of physical objects, software, and connectivity, enabling seamless connection and exchange of information among these entities (Atzori et al., 2010).

Furthermore, it is essential for UAS to be backed by instantaneous and real-time communication while executing their missions. Presently, in this context, the 5G networks are anticipated to provide the ultra-reliable and low latency (URLLC) mode of communication. This would not only fulfill the IoT requirements of UAS but also extend coverage to higher altitudes. In a scenario where UAS encounter competition from an increasing multitude of mobile devices, such as smartphones and tablets, that operate on different wireless networks like Wi-Fi and Bluetooth, all sharing the same spectrum bands. This competition will become increasingly challenging to manage, particularly as the anticipated surge in the number of connected UAS occurs, resulting in potential interferences in UAS communications. In this context, the present system incorporates cognitive radio CR as a promising technology to address these challenges by facilitating Dynamic Spectrum Access (DSA), as suggested by Reyes et al. (2015). Furthermore, the combination of CR and 5G would enable UASs to operate effectively within the IoT framework. This would meet the growing demand for applications that rely on extensive connectivity among devices, including Smart Cities, as indicated by Chourabi et al. (2012).

FIG. 15 illustrates a visual representation of how the layers are connected while transferring data packages. As mentioned earlier, the four layers have been explicitly defined. FIG. 15 demonstrates the order of stages and the potential interconnections between the layers. There are three categories of connections among the layers, encompassing radio links, control mechanisms, and data flows, either within the hardware layers or between the devices onboard. This describes the software and hardware aspects of the network from different perspectives. Simultaneously, variables such as dimensions, data packet quantity, and transfer duration rely on the nature of the data. The selection of data is based on this particular factor, which plays a crucial role in shaping the UAS data network.

At present, the typical approach to establishing a connection entail creating a direct link using either a telemetry device or a WiFi connection. However, in scenarios where UASs encounter congestion, they have to contend with an increasing number of mobile devices (such as smartphones and tablets) operating on other wireless networks (like WiFi and Bluetooth) that utilize the same frequency bands. Nevertheless, apart from disrupting the communication of UASs, this competition will become increasingly unsustainable when a large quantity of UASs is anticipated to be interconnected. This will result in a critical issue of limited available frequency bands and potential security concerns (Saleem et al., 2015). Within this framework, CR arises as a prospective technology to address these challenges. In our model, CR is an intelligent wireless communication system implemented using Software-Defined Radio (SDR), as per the concept of CR. To transition between channels, CR detects and assesses the radio spectrum environment in its vicinity, adjusting its configurations accordingly to enhance reliability and optimize spectrum utilization.

The system employs this technology in instances where the Wi-Fi connection is weak or inaccessible. The system follows a specific guideline to determine the appropriate moment for making this alternative decision. If we identify a loss of data packets within a certain period, it signifies that the Wi-Fi connection is no longer effective. Consequently, we need to shift to the standby CR technology in order to restore the transmission of data. To minimize any extra delays, it is crucial to implement the required settings in SDR configuration.

The connections of these communications within the network's system and subsystems have been established in the following sequence:
1. The supervisory observer in the piloted aircraft tender assigns a target location to each robot UAS based on observations, aerial photographs, or other available data sources. For this operation to take place, it is necessary to utilize command and control links to obtain real-time information regarding the UASs.
2. The supervisory pilot/observer has the ability to visually oversee the progress of each robot UAS as they go through various stages, ensuring that all flight paths are clear of conflicts.
3. The UAS travels to the specified position above the target at a safe altitude, away from any obstacles. It captures a LIDAR image of the target and, based on predetermined criteria, determines the optimal position. Alternatively, it can seek guidance from the supervisor for selecting the best position. In this scenario, it is necessary to establish two-way data communication channels from the Tender to the UAS.
4. The UAS adjusts its position to align with the chosen target and descends to a safe altitude, utilizing LIDAR imaging of the target for navigation.
5. The UAS captures a comprehensive LIDAR image of the target, which is further enhanced by a broad-spectrum photo image. Subsequently, an automated quality check is conducted on the captured image. LIDAR accuracy pertains to how closely a measured or calculated value aligns with a standard or accepted (true) value of a specific quantity. The estimation of LIDAR accuracy is often done by calculating the Root Mean Square Error (RMSE), as mentioned by Njambi in 2021.
6. Once the image and accompanying data satisfy the specified requirements, they are sent to a human observer for a visual assessment of quality and any other necessary evaluations. While this evaluation might cause delays in the timeliness of the data transfer process, it takes precedence when establishing connections between the two layers of the tender and the UASs. It is necessary to prevent the loss of data packets during the transmission process. Starting from this stage, we prioritize the method of cloud archiving.
7. If the image is considered acceptable, the observer on board transfers it to the ground station to be stored in the cloud, undergo further processing, get transmitted to its destination, and then directs the UAS to the next designated objective. If the image is unsatisfactory, the observer will identify the necessary corrective action.

The UAS layer, in FIG. 15, serves as the innermost and primary source of data generation and reception, responsible for transmitting the data to higher layers. The UAS heterogeneous collaborative system consists of a quadrotor functioning as the UA alongside a crewed aircraft. The primary components of the quadrotor include the flight control system FCS, along with a frame, motors, and driver, makes up the essential components for a flight setup. The FCS serves as the core of the UA and is a computer system specifically designed to gather aerodynamic data from a range of sensors such as accelerometers, gyroscopes, magnetometers, pressure sensors, GNSS, and others, as described by Pratt in 2000. The payload of the quadrotor includes the flight control board, which incorporates functions such as the state estimator and control loops. Furthermore, its duties encompass the interpretation of the pulse stream obtained from the radio control receiver, the reception of commands via a serial data port, and the transmission of status updates.

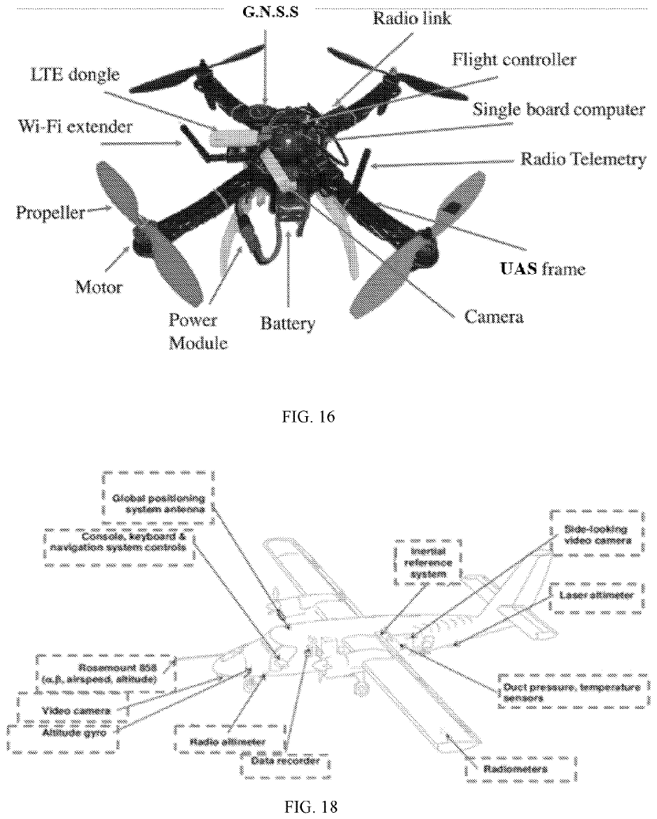

The flight control board is equipped with a three-dimensional MEMS accelerometer, gyroscope, and a sensor for measuring barometric pressure. The flight controller is equipped with a serial port that can be utilized for both receiving commands and transmitting status information. It is connected to a Zigbee module, enabling wireless communication of commands and status information. A collection of sensors, including TV cameras, LIDAR sensors, thermal sensors, and more, is utilized to gather information. This data can be partially processed onboard or transmitted to a base station for additional analysis. The controller responsible for managing the mission or payload. The payload includes a computer system integrated onboard the UA, which manages the operation of the sensors. This operation must be executed in accordance with the progression of the flight plan and the specific mission assigned to the UA, Ultra-Wide Band (UWB) and Telemetry System. FIG. 16 illustrates the locations of these components within the UAVs.

For air-to-ground communications, the data link employs radio-frequency (RF) transmission for the purpose of sending and receiving information to and from the UA. The data that is sent includes a range of parameters such as location, estimated time remaining for the flight, distance to the pilot and target, airspeed, altitude, and information about the payload. Moreover, real-time video captured by the UAS can be sent back to the operator, enabling the pilot and ground crew to observe the outcomes of the UAS's activities (Dimc and Magister, 2006).

There are multiple choices accessible to streamline the operation of the UAS hardware. The flight controller serves as an incorporated computer system, which combines control details from the hardware together with sensor information to oversee the movement of each propeller and guide the UA according to the designated flight parameters. The Micro Air Vehicle (MAV) Link serves as a concise messaging library specifically created for micro air vehicles. Its purpose is to facilitate communication between the unmanned aircraft system (UAS) and the operator, as well as establish an indirect link with the ground control station. This connection is made possible through various transport protocols like TCP, UDP, serial, and USB.

The Robot Operating System (ROS) is a versatile software framework for robots, including autonomous unmanned aircraft, with the goal of streamlining robot control processes. Furthermore, MAVROS serves as a MAVLink expandable communication node within ROS, featuring a proxy that facilitates communication with the Ground Control Station. By utilizing the publish/subscribe communication mechanism in ROS, it becomes possible to transmit MAVLink messages to the UAS via MAVROS. These freely available software and hardware components enable us to engage with the UA, retrieve data from it, and transmit control instructions.

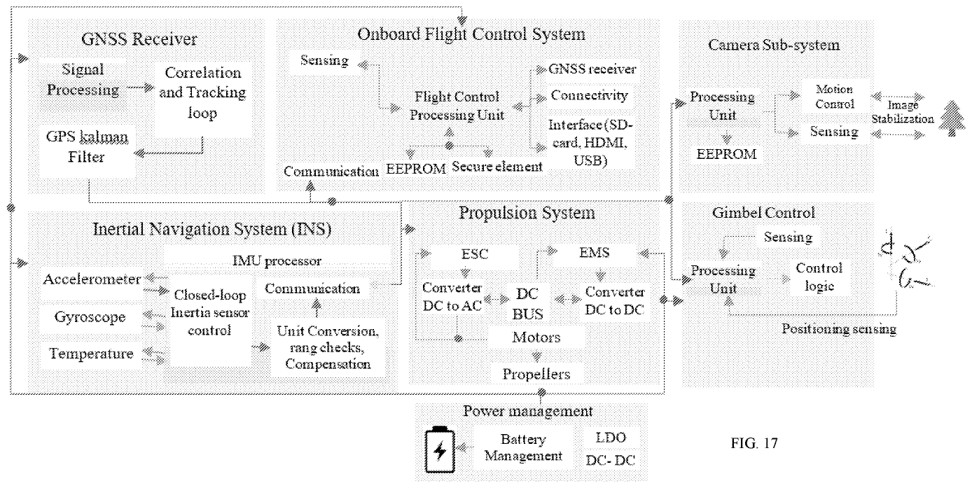

While these two methods are optional, dual forms of assistance are provided, given the widespread usage of ROS. In order to tackle the limitations in financial resources and technical obstacles involved in UA and to ensure that the experimental setup can be reproduced, we assist in simulation environments. The software-in-the-loop (SITL) simulator enables us to reproduce missions without requiring physical equipment. The process entails executing the ArduPilot flight controller software on a nearby computer and gathering information from a flight dynamics model incorporated in a flight simulator. Moreover, Gazebo is a widely recognized robotics simulation software that effectively and precisely replicates clusters of robots operating in complex real-world settings. It is feasible to establish a Gazebo simulator for SITL purposes. FIG. 17 depicts instances of the data flow connections between these components.

The airborne tender serves as the central control hub for the diverse collaborative system, as a bridge linking users to the UAS heterogeneous collaborative system. FIG. 18 highlights the necessary components of the Twin Otter, depicted within a red box. Each specific component has specific data connections with corresponding parts of the UAVs. The subsequent figures illustrate the establishment of relevant data flows between the Twin Otter and UAV components, enabling the design and supervision of a monitoring system by the supervisor within the tender.

Still referring to FIG. 15, the Twin Otter is a utility aircraft with twin engines designed to operate in challenging weather conditions and remote areas. The aircraft has two high-performance turboprop engines and can achieve an average cruising speed of around 300 kph. With its flight range reaching 1,800 km, the distance covered depends on factors such as flight conditions and payload. The aircraft can land on short runways and on surfaces such as soft ground (sand, soil, grass), snow, ice, and even open water. The aircraft can land on short runways and on surfaces such as soft ground (sand, soil, grass), snow, ice, and even open water. The tender consists of several components: wireless communication equipment, a UWB link, a central control board, motors and pilots, a platform, and a vehicle body.

The mission management system acquires uninterrupted aerial data by flying at an altitude of under 100 m from the ground. This approach ensures a spatial resolution of 0.5 m. Xiao Liang (2021) utilizes the magnetometer, accelerometer, gyroscope, and barometer present in both the control board and the flight board to compute the altitude of a UA. The ASPIS remote sensing system, integrated with a Systron Donner C MIGITS III INS/GPS unit (manufactured by Systron Donner Inertial, Concord, MA, USA) and a Riegl LD90 series laser altimeter (manufactured by RIEGL Laser Measurement Systems GmbH, Horn, Austria), is also equipped on the aircraft. The red and near-infrared spectral bands were analyzed to compute the NDVI vegetation index. Terra system Srl's proprietary software performed a radiometric correction on the sensor. ITT Visual Information Solutions, USA, utilized the ENVI FLAASH module (Fast Line-of-sight Atmospheric Analysis of Spectral Hypercubes) for conducting atmospheric correction.

This module employs an algorithm developed by Spectral Sciences, Inc (Burlington, MA, USA). To eliminate internal optical distortions of the sensor and those resulting from altitude variations, a geometric correction was conducted using the software PCI Geomatic (developed by PCI Geomatics Corporate, ON, Canada). Within this network, the UAS Camera captures real-time images, while the image transmission station is responsible for transmitting the UAS-obtained video information to the Tender. The Tender receives digital and image data from the UAS and, after processing, sends control instructions back to the UAS. The process involves capturing georeferenced high-resolution images of points on both the Tender and UASs. The aerial data were orthorectified using an aerial model as the algorithm. The aerial orthoimage, composed of a mosaic of two frames, was generated with a ground resolution of 0.50 m and georeferenced in the WGS 84-UTM 32 North reference system (Alessandro Matese, 2015).

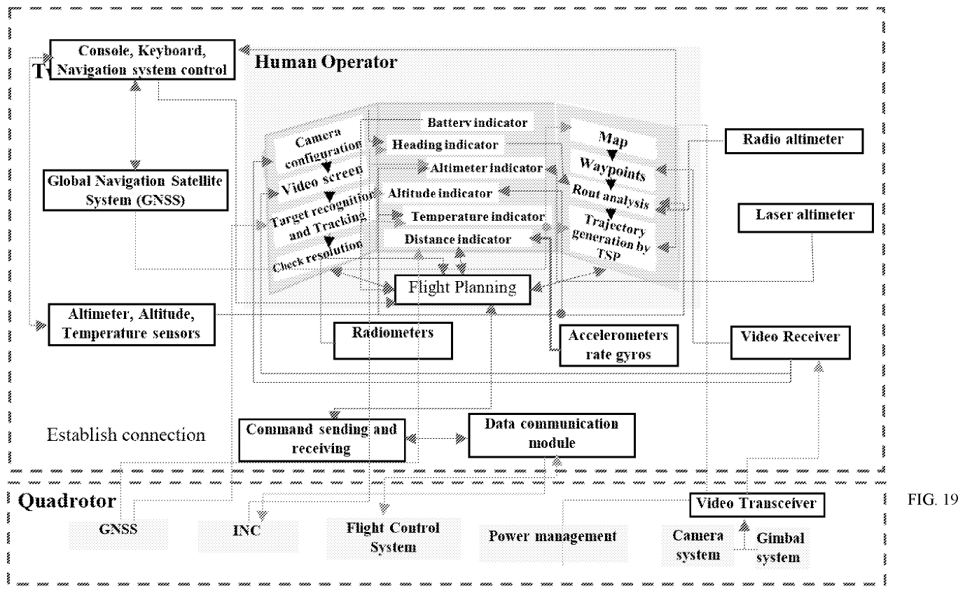

FIG. 19 demonstrates the sequential process of establishing data links during flight operations. The data flow diagram depicted in the figure pertains to the first layer of the network, specifically among the Tender and the UA. As depicted in FIG. 19, the UAS layer transfers the data collected by its sensors to the Tender. Subsequently, a human operator examines the data and archives the received information in a database. Ultimately, some of the data is transmitted to various functional modules for visualization. In contrast, another data segment is utilized for computations such as path planning, decision-making processes, and control commands. The data communication module is crucial in establishing the connection between the Tender and the heterogeneous cooperative system. The communication performance serves as a critical foundation for the Tender to display and process data effectively. The UAV, Tender, and ground station communicate and exchange data among themselves via a serial port.

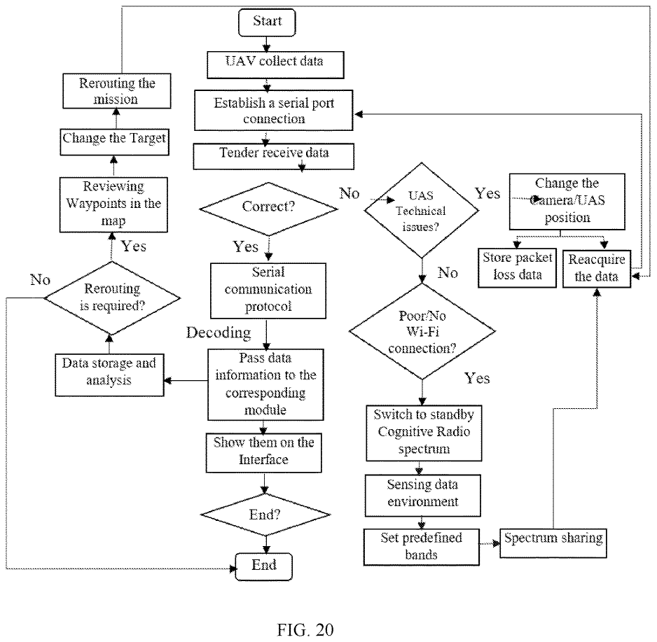

FIG. 20 depicts the diagram illustrating the process of data reception by the human operator within the Tender layer. Due to the substantial volume of received data, the primary thread of data communication is analyzed, and a portion of it is distributed to separate components, including Image display, Data display, and digital map.

Still referring to FIG. 15, the ground station serves as a cloud-based server's location, enabling the expansion of UAS applications. The Tender must establish direct connections with the ground station to enable communication and control. However, this line-of-sight communication link could be better for extensive and widespread operations. It imposes constraints on the ground station's placement, limiting it to the mission's location. It also mandates that the Tender and UAS remain within direct sight of the ground station or accessible communication hubs. This limitation is not preferred for more extensive scale and distributed operations (Mahmoud et al., 2015). Furthermore, the control and monitoring of UAS applications become more intricate and restricted, limited only to specific devices with which the UASs are connected.

The system combines the UAS network by leveraging the Cloud Computing (CC) paradigm. The scope of cloud computing has expanded beyond computers and mobile devices to include embedded systems (Mell and Grance, 2009).

The purpose of this layer is to transform UAS into cloud-based resources and offer clients a functional approach that is entirely detached from the specific characteristics of the UAS. Furthermore, functioning as an intermediary that links the tangible UAS with the cloud, this stratum assumes the responsibility of transferring the data obtained by the Tender to the cloud for processing (relocating computational tasks). Additionally, it transmits the processed outcomes back to the Tender for implementation (assigning missions). The UAS can send messages using multiple network protocols, which necessitates providing and maintaining diverse communication interfaces tailored to each protocol. To establish communication with the ROS node, we employed rosbridge (Crick et al., 2017) to actively initiate Websocket-based communication to the Tender layer. There are numerous advantages to using WebSockets: on the one hand, Websocket are supported by multiple programming languages, making integration with web applications more superficial and more convenient. MAVLink is a communication protocol that operates across transport protocols such as UDP, TCP, Telemetry, and USB. It enables the transmission of pre-established messages between the UASs and the Tender and between the Tender and ground stations. In conjunction, ROS and MAVLink offer a high-level interface that empowers application developers to monitor and control drones without requiring direct programming and hardware interaction. On the flip side, rosbridge utilizes JSON format for message transmission, ensuring compatibility with various operating systems and resulting in lighter message uploads. The Tender must undergo authentication to access cloud services at the access point. Once the authentication process is completed, the cloud will establish and maintain the connection, preserving it through a thread pool. Hence, this module has been devised as a multi-threaded server, enabling more efficient handling of MAVLink and rosbridge messages from the Tender layer.

As the system is designed for Tender operators, it necessitates permission matching between the Tender and control station operators to avoid conflicting control situations. When utilizing CR-supportive technology, the SDR sets its transmission frequency through software instead of hardware. This capability enables the CR to intelligently switch to different channels as needed. In practical terms, CR comprises a hardware component coupled with an intelligent software system. Typically, the hardware configuration encompasses a radio platform, typically in the form of an SDR and a computational platform. Single-board computers, like ODROID (Hardkernel Co, 2020), Raspberry Pi (Raspberry Co., 2020), and Beagle Board (Texas Instruments, 2018), are the predominant computational platforms utilized in CR applications. The Universal Software Radio Peripheral (USRP) developed by Ettus Research (Ettus Research, 2020) and the Wireless Open-Access Research Platform WARP created by Rice University are two widely utilized software-defined radios SDRs that serve as common radio platforms in CR applications.

Since data is sourced from various UAS groups, it is crucial to establish specific permissions for operators within each group. To efficiently maintain UAS resources, we have developed a UAS manager that facilitates storing and managing essential UAS information, including details such as UA type, size, firmware information, and more. This enables us to handle UAS resources swiftly when needed.

To make it easier for operators to comprehend UAS hardware, we have incorporated UAS within the UAS Access layer in the tender layer. This enables more straightforward methods for controlling the aircraft, allowing developers to concentrate on developing the control station without requiring detailed knowledge of the UAS hardware. The subsequent paragraphs will delve into the various components present within this layer.
The UAS Remote Controller encompasses all the action-related data that can be performed on the UAS. It encompasses MAVLink Command messages and the ROS-associated UAS actions, such as take-off, landing, navigation to a specific location, returning to the launch site, capturing photographs, and more.
The Mission & Mission Control component serves the purpose of enhancing the UAS's autonomy in performing tasks. Numerous mission types necessitate distinct behaviors. The waypoint mission is the most frequently encountered type. A waypoint mission entails a sequence of predetermined latitude, longitude, and altitude locations (waypoints) the UA will navigate to. Performing a series of actions, such as capturing a photograph, is possible at each waypoint. The UA receives and executes a waypoint mission uploaded to it. The Mission & Mission Control component oversees and prepares more intricate tasks requiring advanced management. Mission Control is in charge of carrying out mission executions. There are two options for running missions: a dedicated mission operator can execute a single task, or a series of assignments and actions can be conducted sequentially using the timeline feature. The mission can be manually modified and adjusted through this component, allowing for acceleration, deceleration, and even reverse execution.
Due to the multitude of sensors carried by UAS and the variability of data types, particularly in ROS, using different topics by sensors of the same kind to publish messages can cause difficulties in the development process. Our system involves the implementation of a Sensor Manager module that consolidates sensor information into a standardized representation way.
The primary function of the UAS Shadow Files component is to mirror the real-world status of a UAS as a digital twin in the cloud environment. When the UAV system is operational, it relays its internal status to the UAS Shadow component via the Sensor Manager. This information is then stored as a temporary status using a file format in JSON. Other components can access the status of the UA through this file. To enhance system stability in demanding wireless environments, the design of this module considers the potential instability of the network. The UA communication link's intermittent online and offline connectivity can be attributed to network instability. The cloud-stored Shadow File serves two purposes in mitigating such issues:
Firstly, it maintains the most current status of the UA and promptly synchronizes it whenever a state change. Secondly, the Shadow File stores control commands and timestamps, allowing them to be retrieved after the UA reconnects. The execution of these commands is determined based on the respective timestamps. This approach aids in alleviating network traffic congestion when bandwidth is limited.

When multiple control stations want to request the status of the UA, the system has to perform multiple network dispatches, but the results are uniform. The best way to handle this is to synchronize the status with the UAS Shadow Files. This approach decouples the control station and the UAS, and the capability of the UA is also relieved.

Storage & Data Tools: These elements offer storage solutions for data from the UAS. While the tender layer is an intermediary layer, the initial data source is obtained through the UA. Determining how to store data is crucial not only for guaranteeing its quality but also for its overall importance. The UAS requires storing, retrieving, and accessing various types of data. After analyzing the data through the tender layer, we categorize it based on its type and store it in different databases that meet the specific requirements of each application. Mission data, environmental details, and transmitted data may include various sensor readings like images, videos, GPS coordinates, etc. As an illustration, SQL databases can store consistently organized data, like the details about the UAS and its verification. The NoSQL database allows for gathering unstructured data, including information like location coordinates and temperature, among other things. The NoSQL database can collect unorganized data like location coordinates, temperature readings, and similar information. Batch operations are well-suited for handling sizable files like flight records and UAV missions, as they do not necessitate quick processing. Hadoop is a specialized framework designed for executing batch-processing tasks. The information is accessed by utilizing the HDFS file system and undergoes processing using the distributed technology Map/Reduce, resulting in valuable data extraction.

Virtual Environment: As the number of UAs increases, the single-node server cannot handle extensive computations on a large scale. Virtual machine technology has emerged as a powerful method for server clusters. We opt for Docker and Kubernetes to streamline scheduling and server management. Docker facilitates the creation of virtual container runtime environments, while Kubernetes oversees the organization, coordination, and scheduling of container groups generated by the Docker engine.

Intelligence Engine: The Intelligence Engine relies on various algorithms to support the execution of tasks for UAVs, including task planning, SLAM (Simultaneous Localization and Mapping), trajectory optimization, and more. The Intelligence Engine can engage in simultaneous processing by utilizing a Hadoop cluster. It employs the Map/Reduces technique to enhance the efficiency of executing algorithms. Additionally, many big data tools in the cloud can support Data Analytics algorithms. Generally, their objective is to offer intelligent capabilities and logical thinking within the cloud.

### Simulation and Experiments

This section presents the experimental evaluation study, which utilizes the SITL to showcase the efficiency and effectiveness of the control system architecture. To begin with, we demonstrate the utilization of SITL to replicate numerous genuine UAVs to compensate for the lack of experimental circumstances. Next, we present the control station application that operates on the web, utilizing our system's architecture. We employed the method for internet-based management and surveillance of UAVs, explicitly using the web as a medium. The Cloud Layer enables this capability by providing Web services and WebSockets interfaces.

The SITL (Software in the Loop) simulator provides us with the capability to operate Plane, Copter, or Rover-like vehicles in the absence of a physical autopilot system. We can interact with these vehicles through MAVLink communication over the local IP network. SITL, in reality, replicates a dynamic flight model primarily built upon the flight control algorithm of ArduPilot. When we initiate SITL, our personal computer becomes a UAV platform where ArduPilot can be constructed and executed. Nevertheless, SITL involves compiling the autopilot code with a standard C++ compiler, leading to increased complexity in its operations. DroneKit-SITL offers a quick and effortless method to execute SITL on various operating systems. Since DroneKit-SITL is created using Python, it can be installed on any operating system using Python's PIP tool. It offers a set of uncomplicated commands that allow users to initiate pre-existing vehicle binaries. There are a range of ports for TCP connections. These ports are specified and controlled in SITL.

After initialization, SITL remains in a state of readiness, awaiting a TCP connection on port 5760. Monitoring the UAS status simultaneously using multiple software applications during the simulation might be necessary. For instance, when UAS are controlled using scripts, data is received through ground station software. However, the current SITL setup cannot meet this need since it only supports a single connection port. To address this issue, we employ MAVProxy to transmit the MAVLink data packets from the UAS across the network using UDP. This transmission is directed to various other software applications on remote devices, including onboard and ground stations. Beneficial when employing multiple computers or transmitting the stream via an intermediary node. Appendix B has provided instructions for controlling this structure. Additionally, the input structure of the hierarchical block comprises a series of intricate samples received through the simulated interference channel. At the same time, its output consists of a sequence of complicated models transmitted via the fake interference channel.

To replicate multiple UAVs in a simulation, it is necessary to configure the DroneKit-SITL parameter called “-Instance N.” In this context, SITL (Software-in-the-Loop) assigns port numbers by adding ten times the value of “N” to each port. This also applies to our radio connection network. The process occurs within a Python script that creates a flowgraph step-by-step. This flowgraph consists of N transceivers, each representing an individual network node's receive signal paths and transmission. Additionally, the script establishes an interference channel between these transceivers by utilizing N×N channel blocks. Appendix A includes a high-level block diagram of RF-SITL, as depicted in A1.

We begin simultaneously simulating a group consisting of a Twin Otter aircraft and two UAVs. Twin Otter was prepared to take off by following the prescribed commands architecture after being equipped with the designated hardware and software. The diagram labeled A1 illustrates the flow of data when both the UAS and the Tender are in flight simultaneously. The Tender is required to ascend to a height of 40 meters before continuing its journey, passing through various mission waypoints, most of which are at an altitude of 100 meters. At any given moment, you can halt or temporarily pause the mission by adjusting the mode.

Please be aware that MAVProxy can connect with only a single UAS simultaneously. If you want to control multiple unmanned aircraft systems (UAS), it is recommended to employ several MAVProxy sessions, with each session dedicated to one UAS. The message is forwarded through a UDP connection by MAVProxy, and we utilize Mission Planner to observe the forwarded message. The connection of MAVProxy can also be established through alternative software or interfaces, and we use this capability to transmit data to the cloud.

Web-based Control Station. The Python web framework Django is responsible for creating the Cloud Layer control system. We placed the server inside a Docker container. The web station comprises essential UAS details, such as altitude, ground speed, airspeed, battery status, attitude angle, GPS coordinates, flight duration, and more. As previously stated, to guarantee the promptness of the information, it is necessary to have a dependable two-way communication system in place to receive the MAVLink data stream from the Tender Access component. FIG. 1 illustrates the graphical user interface of the web-based control station system. The map view displays two operational UASs, each equipped with a functional control panel and a heads-up display (HUD). The web control station utilizes a JavaScript WebSocket client to establish a connection with the Cloud's Websocket interface. When the UAS data is transferred, the cloud interface operates gently. The system is linked, creating a distinct UAS control panel widget accompanied by a one-of-a-kind color and identifier.

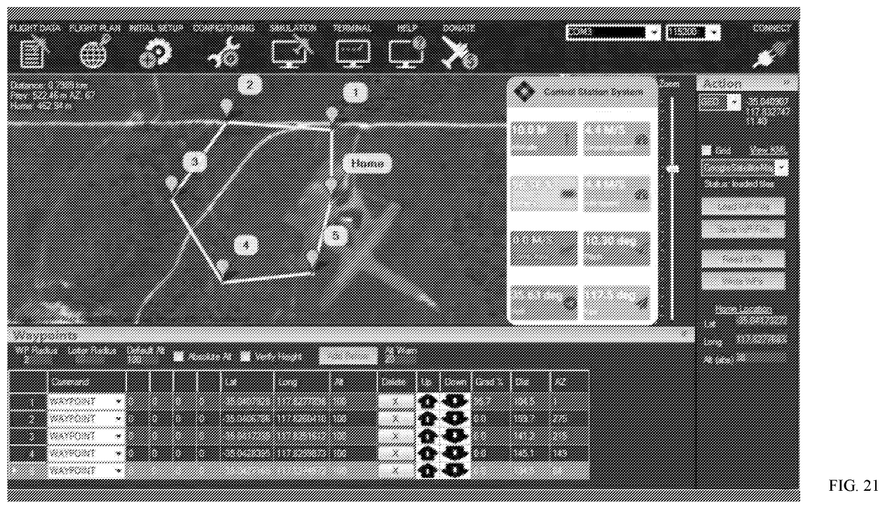

In the SITL, the control panel displays the modified aliases of the tender and the UASs, along with a green LED indicating their communication link status. Additionally, buttons are available to transmit control commands to the tender and the UAS. The sequence depicted in FIG. 21, moving from left to right, consists of the following actions: initiating takeoff, entering a hover state (pause-mission), proceeding to a designated location (go-to), capturing a photograph (take-photo), landing, restarting the mission, returning to the home location, and arming or disarming the system. Moreover, a few additional control buttons exist, such as the option to adjust the altitude. The execution of these control commands takes place via a Restful web service interface facilitated by the cloud, employing remote invocation. To illustrate, the web control station system calls upon the takeoff function provided through the Cloud Layer Web service when taking off.

Request the specified IP and port, targeting the UAV Control System API and the Control Service endpoint. The purpose is to initiate a take-off action for the unmanned aircraft system identified by ‘x’ and at the height of ‘y’. We refer to the web service for UAS control concisely because the UAS Shadow Layer effectively encapsulates the fundamental actions of UAS. The take-off service only requires the height parameter to be passed, but several repetitive movements must be carried out at the UAS Remote Controller module. These actions involve checking if the UAS can be armed, setting the mode to GUIDED, and sending commands for arming and take-off.

Furthermore, no feedback is transmitted by the UAS to notify the user that the desired altitude has been attained. To tackle the problem, we gather the UAS's relative height at consistent intervals and then compare it to the anticipated measurement. If the mistake falls within a predefined scope, it is deemed to have attained the desired elevation.

This disclosure introduces a new UAS network system that combines UAS with a manned aircraft called the “Tender” and the GS. The architecture incorporates a cloud-robotics approach, enabling the Tender to manage and supervise multiple UAs via the Internet remotely. The model's design is a control system overseeing data flow during the flight mission. The prioritization of data transmission and reception showcases the ability of a human operator to observe the collection of data and verify its accuracy. Next, all the desired targets will have the same process to be investigated and tracking by the UAS and analyzes by the tender qualitatively. To determine the efficiency of the architecture, the system includes a control station on the web using the control system architecture interface. Due to the intricate nature of unmanned systems, several possible expansions exist in our architecture. Initially, we employ freely available SITL software to expedite the development process. The findings indicate that data transmission has occurred with a minimal delay compared to the conventional UAS data network, which consists of primary and standard network components. This approach offers a novel method to uphold data quality while ensuring efficient data transfer. However, it is worth noting that we neglected to consider security concerns. An additional obstacle pertains to the issue of coordinating missions involving multiple UASs. The architecture is capable of managing various UAs.

### Forested Areas

In one example embodiment, the forested areas that the system can study are coniferous (white spruce, lodgepole pine, and black spruce) and deciduous (trembling aspen, balsam poplar, and white birch). These forests are located in the Upper Hay Regional Forests of Alberta. Tree ages in previously harvested areas are young (5-7-years old and 15-17-years old), growing adjacent to either previously harvested or mature forests, which are 30 meters tall for mature forests, or 15 meters tall for black spruce/tamarack stands, or 5 to 20 meters tall for previously planted areas. Previously harvested areas are from one to 150 ha in area. Coniferous reproduction is planted, while hardwood reproduction is natural.

Among other things, the rate at which a plant grows is intimately related to climate. If a forest of trees grows at the same rate year after year, then we can assume that the climate (temperature, rainfall, etc.) is more-or-less constant from year to year. The sensitivity of trees to climate affects their rate of growth. Trees' rate of growth can be measured by ring width and rate of growth in height. Ring widths can be measured by taking an increment core from a tree. Growth in height can be observed in trees by measuring the distance between whorls of branches, especially for conifers. The distance between branch whorls is called the internode (branch whorls are called nodes).

The system measures both ring widths and lengths of internodes. For larger, mature trees, ring widths are measured from increment cores, while for younger trees, internode lengths can be measured directly or by the use of LiDAR. The advantage of LiDAR is that a large number of trees can be measured in a short period of time. Ring width and latewood density, which are both measured using increment cores, provide an accurate way to measure rate of growth (ring width) and wood quality (earlywood and latewood density). The system correlates lengths of internodes with ring widths and latewood density to monitor how these forests are growing.

“Forestry”, as described here, relates to the more traditional, but vitally important, field work. Data collection includes tree species, DBH, geolocation, and photographs. Phase 1, year 1: field work, conifers. Tree heights: Heights are measured with a clinometer. For younger trees, rate of height growth is also measured by measuring lengths of internodes. A 200 mm-long, white-painted stick is used as a length reference to measure internode lengths. The trees are photographed with the reference stick held next to the stem so that accurate measurements can be taken from the photographs later in the laboratory. Thirty of the young trees are measured.

Increment cores from mature trees: For mature trees and those that are ten or more meters tall growing adjacent to harvest areas, we take 5-mm increment cores from 30 trees. Each tree is numbered and its geolocation is recorded. Cores are placed in plastic tubes of appropriate diameter after spraying them with a dilute thymol or bleach solution to prevent mold growth while they are taken to Syracuse for study in the lab. Cores are taken from 30 trees.

Phase 1, year 1: field work, hardwoods (similar in scope to conifers). Young trees: For younger trees, diameters are measured with a caliper. The trees also are photographed while holding a 200 mm-long, white-painted stick held vertically next to the stem as a reference for measuring height and a 100-mm long stick held horizontally on the stem as a diameter reference when measuring tree height and diameters from the photographs in the laboratory. Thirty trees are sampled.

Increment cores from mature trees: For mature trees and second-growth trees that are ten or more meters tall growing adjacent to harvest areas, the system takes 5-mm increment cores from 30 trees. Each tree is numbered and its geolocation is recorded. Cores are placed in plastic tubes of appropriate diameter after spraying them with a dilute thymol or bleach solution to prevent mold growth while the cores are taken back to Syracuse for study. Sample size is thirty trees.

Phase 1, year 1, lab work, conifers. Increment cores from mature trees: Increment cores are surfaced to ensure that the growth rings and anatomical features of the wood are visible. Then the cores scan with a flat-bed scanner to generate data that includes ring width, earlywood density, and latewood density for analysis using WinDENDRO software. This software provides highly accurate data on ring width (growth rate) and wood density.

Internode lengths, young trees: Digital photographs of individual trees are examined using a computer with moderate magnification to ensure accurate measurements. Spreadsheets of the lengths of each internode are generated starting at the top of the tree, so we know the calendar year in which each internode formed. We then have a database so we can compare the rates of growth per year for each measured tree. Health of individual trees can be estimated based on their rates of growth but more importantly, variability in climate, particularly drought conditions, can be assessed by comparing ring widths and internode lengths from year to year for the taller and older trees. Wood density is closely correlated with tree health particularly soil moisture.

Phase 1, year 1, lab work, hardwoods. Compare photographic evidence of tree growth rates with lidar data. Phase 1, year 1 data analysis. It is probable that both young and old trees react in a similar manner to climatic factors. However, soil moisture stresses no doubt affects smaller trees to a greater degree because they have smaller root systems. In addition, temperatures in a forest stand with a closed canopy are normally cooler than in a stand with a more open canopy. The cooler, shade-induced temperatures could mitigate some of the climate-related temperature effects on tree growth. These are some of the factors that are considered during analysis. These coniferous and deciduous trees have different preferences for site conditions, particularly soil moisture availability, so we very well may observe differences between the softwood and the hardwood stands regarding possible drought as well as growth in general.

Phase 2, year 2, field work, conifers and hardwoods. Variability of the first-years data analysis is used to set the most appropriate sample size for the second year's field work.

Procedures used for the first year's field work is revised, if necessary, before beginning the second year's work based on lab analysis of data collected the first year. For the second year, the size of the data set is much greater because remote sensing data on the trees, such as lengths of internodes and tree diameters is also collected. Phase 2, year 2, lab work and data analysis, conifers and hardwoods Prepare a master chronology of the rates of growths for both conifer and hardwood mature trees and regrowth trees based on ring widths and latewood density.

It is important for the system to look for any individual years or series of years in which tree growth was less than or more than expected to see if there was a climate or other effect. Also, growth rates and latewood densities are compared, since latewood density is related to late-season drought conditions, which may not be demonstrated by ring widths if early-season rainfall was sufficient for good over-all tree growth, but late-season drought reduced latewood density. A comprehensive analysis of the rate of tree growth is indicative of the general health of the forests. Spectral analyses reveals evidence of tree health when leaf color is affected by disease, insect attack, drought, etc. Aerosol sampling alerts us to beginning stages of insect attack as well as forest health in general.

Objectives related to remote sensing. There are two main objectives: Objective-1: To study and monitor the growth and development of harvested blocks for younger 4-7-year-old seedlings and 12-15-year-old saplings, including: Stems per hectare, Tree height, Tree species, Possibly drought. Objective-2: To study health and condition of the older forests growing adjacent to the regrowth blocks studied for Objective 1. Forest condition, as related to climatic effects such as drought, is monitored by spectral analysis. Tree diseases are monitored by sensing aerosols and pheromones from insects. Primary interest is on: Drought, Tree diseases, Insect infestation. Data Collection with High Resolution RGB, LiDAR, Hyperspectral, Field data (forest plot inventory) and re-growth rate measurements

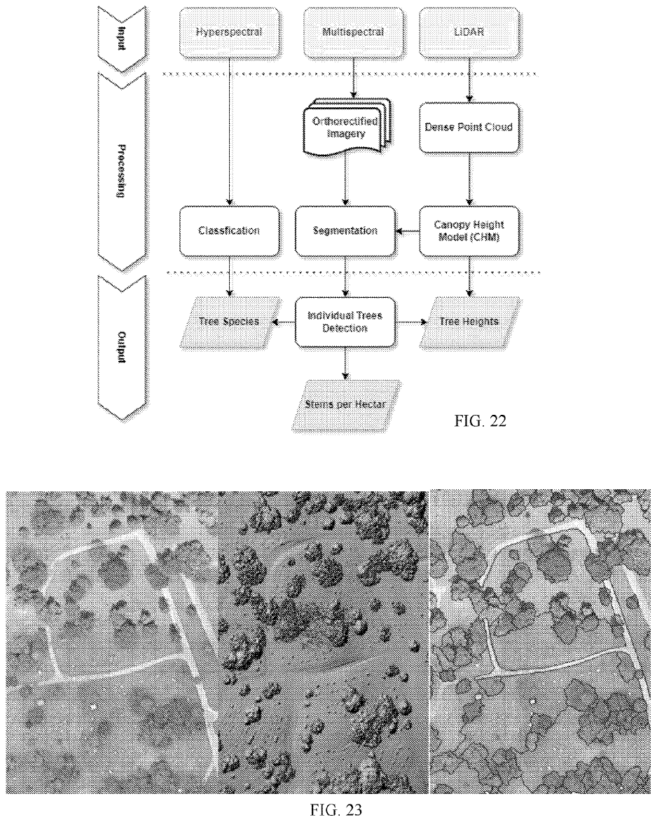

Data Processing, Methods, and Tasks. Project 1 leads to the products requested by Tolko as indicated above. A series of photogrammetric, machine learning, and lidar processing methods are developed and implemented in Python and other open-source data processing tools to build a software tool for automatic generation of such products. Such tools have a Graphic User Interface (GUI) that can be used by Tolko with training for ongoing monitoring of their forest properties. FIG. 22 shows a flowchart of steps involved in generating the products. All three sensors play a critical role for the generation of the three products. LiDAR are used for forest canopy height (CHM), while multispectral data are used along with LiDAR for segmentation leading to detecting individual trees (and stems/ha). Hyperspectral data are used for tree species classification and health/disease monitoring of trees.

The first and foremost important step in measuring individual tree properties such as height, species, density, stems/ha from UAV imagery is to automatically detect and extract individual trees from the imagery. Tree detection using decimeter level resolution imagery collected by UAVs is now feasible. Tree detection algorithms either use information from 2-D image or from 3-D LiDAR point cloud. While the first approach is simple and faster it fails to distinguish individual trees from a tree patch (with different heights) in a forest stand. In other words, 2-D detection is more effective for sparse forests with individual isolated trees. 3-D point cloud, on the other hand, considers tree height information and thus is more effective in separating trees with various heights that grow close together. However, 3-D point clouds cannot pick up the precise boundaries of tree crowns (no spectral information is used) and results are often not as desirable. In this project, the system combines both approaches to generate individual tree maps. The tasks include: (1) Multispectral image processing to create ortho rectified image; (2) Conducted multi-resolution segmentation on the orthorectified image to extract individual trees for large areas. (3) Calculate the number of trees per hectare. The system was configured to a) automatically detect individual trees and consequently estimate trees per hectare and b) automatically estimate tree height from the DSM and forest canopy height generated.

After individual trees are detected, their corresponding heights are determined. There are several methods for tree height estimation using UAV photogrammetry, including structure from motion and lidar-based methods. Structure from Motion (SfM) is a computer vision technique that can be used to estimate the 3D structure of a scene from multiple images. In this method, the images captured by the UAV camera are processed using SfM algorithms to generate a dense 3D point cloud of the forest, including the treetops. The height of individual trees can then be estimated by measuring the height of the treetops in the 3D point cloud. Lidar-based methods: In these methods, the tree height is estimated using LIDAR data, which is collected by a LIDAR sensor mounted on the UAV. The LIDAR data can be processed to generate a high-resolution 3D point cloud of the forest, including the treetops. The height of individual trees can then be estimated by measuring the height of the treetops in the 3D point cloud. These are the main methods for tree height estimation using UAV photogrammetry, though any suitable method can be utilized. The choice of method depends on the specific requirements of the project and the available resources, including the quality of the images, the complexity of the forest structure, and the desired accuracy of the results. The system integrates both methods to increase accuracy.

Once individual trees are detected in large forest areas, the species types are determined using hyperspectral data. As illustrated in FIG. 22, the tasks include Hyperspectral data collection and spectral calibration Classification of hyperspectral data. The system uses Random Forest Classification. Random forest Classification is a non-parametric classifier which does not required huge training sample size. The classification results label each tree species. It is worth mentioning that this is a supervised classification, which means that it requires training samples which are pre-determined trees with their species. The classifier is trained on a small sample of trees with various species across the area. It then applies to the larger areas to automatically determine species.

Field work related to increment coring and internode measurements identify the species of representative trees with their geolocation data. If this data is of sufficient quality, the system uses it to train the species detection algorithms. Detecting species of conifers should be relatively easy in view of the fact that the colors of spruces and pines are so distinct. The accuracy of separating white and black spruce remains to be seen. Separating willow from the cottonwoods also should be relatively easy. Field observations is carried out to test the accuracy of separating trembling aspen from balsam poplar.

A system of drones, equipped with the sensors described above, are controlled by a piloted aircraft equipped with supervised two-way radio communication to the drones. This work evaluates and assesses the using a wireless control system involving multiple unmanned vehicles (UAV), commanded and supported by a manned “Tender” air vehicle carrying a pilot and flight manager equipped to monitor and manage multiple diverse UAV over inaccessible terrain through wireless communication. The architecture facilitates operations and analysis on the fly, enabled by means to detect, assess and accommodate change and hazards on the spot. The “Tender” vehicle suite of air-to-air UAV control and software which is capable of “ground to air” management systems.

The “Tender” architecture facilitates operations and analysis on the fly, enabled by means to detect, assess and accommodate change and hazards, on the spot with human oversight. The “Tender” air vehicle will typically fly higher than a UAV's maximum altitude above the terrain, managing the UAV operations and hazards from above. The “Tender” also includes radio (or optical) communication and command data buses with the UAV “flock”. Sensors to detect and monitor terrain, collect data and software to evaluate the data in real time is mounted on the UAV.

### CONCLUSION

This disclosure presented and evaluated a concept for a manual-automatic data acquisition network using several UAVs piloted by a manual tender aircraft. The presented model describes an architecture for the optimal position of the UAVs such that they are equipped to satisfy the three objective functions. The routing was performed in this model in the direction of the first objective function to transfer high-quality and correct data within defined time frameworks. As such, the model faces a penalty outside their range. In the second optimization, involving cloud processing of data, the data storage is prioritized by defining a meaningful relationship. Finally, in order to maintain and improve flight safety, the probable risks during the operation were detected via the BNN method, and the consequences of their occurrence were evaluated through the AHP method using expert opinion and historical data in order to minimize the probable risk level under unpredictable conditions. The model was executed using an extended MORL algorithm. The results indicated that the designed network succeeded in determining the optimal trajectory for the UAV and detecting the best possible policies by determining the most optimal possible states and actions for the UAV during its flight course. Specifically, after 3000 episodes in the update Q-learning methods, the MSE index indicated that the prediction by the algorithm reached its minimum error, which was close to zero. This demonstrated the high performance accuracy of the MORL algorithm. On the other hand, the similar convergence trends of the assigned rewards and the collected data, shown in FIGS. 10(a), 10(b), indicate that the algorithm performed well in increasing the collected data, such that the rewards increased and approached zero in the final episodes.

In the present system, the model struggled to estimate the time framework in data collection. This is because the determination of possible the delays and outages are inaccurate due to the different speeds of the UAV and the tender aircraft. This especially true given the fact that the UAVs must maintain their position at a specific altitude when collecting data until the required data from the trees in an area are fully acquired. Thus, calculating the time required to maintain the radio link between the UAVs and the tender aircraft needs considering such details. On the other hand, using stronger and more advanced links, such as terrestrial 5G networks or over-the-horizon satellite can improve the reliability of the network in guaranteeing the quality of the collected data and minimize the probability of outages and time delays.

The disclosure has a number of embodiments, some of which are stated here. In one embodiment, an unmanned vehicle system has a plurality of unmanned vehicles (UV), each of said plurality of UVs having a UV processing device; and a manned control vehicle having a control vehicle processing device in wireless communication with all of the UV processing devices of all of said plurality of UVs, said control vehicle processing device simultaneously and in real time controlling operation of all of said plurality of UVs during flight of said control vehicle and said plurality of UVs. In another embodiment, a UV sensor is positioned in each of said plurality of UVs and dynamically detecting in real time a flight condition and/or UV condition, said UV processing device receiving in real time the detected condition and transmitting the detected condition in real time, and said control vehicle processing device receiving in real time the detected condition transmitted by said UV processing device and determining in real time operation of said plurality of UVs based on the detected condition. In another embodiment, the flight condition comprises an object on the ground or characteristic of an object on the ground. In another embodiment, the flight condition comprises a hazard. In another embodiment, the UV condition comprises an altitude or GPS coordinate. In another embodiment, said control vehicle processing device further dynamically determines in real time operation of said plurality of UV based on a target location. In another embodiment, the control vehicle processing device positions said plurality of UVs over the target location.

In another embodiment, the control vehicle processing device dynamically controlling operation of said control vehicle in real time. In another embodiment, the control vehicle processing device dynamically controlling operation of said plurality of UV vehicles in real time. In another embodiment, the control vehicle further having a rotor, propeller, throttle, flight controller, control sensor, and/or GPS. In another embodiment, each of said plurality of UVs further having gimball control and flight control systems. In another embodiment, said UV sensor comprising a radar, LIDAR, and/or imaging. In another embodiment, said UV comprises an unmanned aerial vehicle. In another embodiment, said control vehicle comprises a tender. In another embodiment, said control vehicle processing device coordinates operation of said plurality of UVs and said manned control vehicle.

In another embodiment, said plurality of UVs and said manned control vehicle are aerial vehicles. In another embodiment, said control vehicle has a control vehicle wireless communication device and each of said plurality of UVs has a UV wireless communication device, and wherein said control vehicle processing device wirelessly communicates via said control vehicle wireless communication device to each of said UV processing devices via said UV wireless communication devices. In another embodiment, said control vehicle processing device communicates with each of said UV processing devices by radio-frequency signals. In another embodiment, said control vehicle processing device monitors and manages said plurality of UVs. In another embodiment, said control vehicle processing device determines a flight plan, transmits the flight plan to said UV processing devices to control operation of said plurality of UVs to coordinate operation of all of said plurality of UVs. In another embodiment, each of said UV processing devices receive the flight plan from said control vehicle processing device and said UV processing device controls operation of said UV based on the flight plan.

In another embodiment, said control processing device controls operation of said control vehicle based on the flight plan. In another embodiment, said plurality of UVs has a UV flight controller and said UV flight controller controls operation of said UV. In another embodiment, said UV flight controller receives the flight plan and controls operation of said UV based on the flight plan. In another embodiment, said control vehicle has a control vehicle flight controller and said control vehicle flight controller controls operation of said control vehicle. In another embodiment, said control flight controller generates the flight plan or receives the flight plan from said control vehicle processing device. In another embodiment, each of said plurality of UVs has a different flight path and/or mission, and the flight plan is configured based on the flight path and/or mission of said plurality of UVs. In another embodiment, a ground station with a ground station processing device configured to generate a flight plan, transmit the flight plan to said control device processing device and/or said UV processing devices to control operation of said control device and said plurality of UVs to coordinate operation of all of said plurality of UVs and said control device.

In another embodiment, said ground station processing device or said control processing device having a risk assessment model configured to determine risk indicators using an integrated SORA-BBN (Specific Operation Risk Assessment-Bayesian Belief Network) approach while its resultant analysis is weighted through the Analytic Hierarchy Process (AHP) ranking model. In another embodiment, said ground station processing device or said control processing device is configured as a convex optimization model and a low complexity MultiObjective Reinforcement Learning (MORL) algorithm to map UV device to make optimal movement decisions. In another embodiment, a UAV-assisted data network configured to provide coverage for the Internet of Things (IoT).

In the embodiments shown and described, the system 5 can include a processing device 120, 220 to perform various functions and operations in accordance with the disclosure. The processing device 120, 220 can be located at the respective Tender 102 and UV 202, or can be located remotely and in wireless communication with a processor at the Tender 102 and/or UV 202. The processing device can be, for instance, a computer, personal computer (PC), server or mainframe computer, or more generally a computing device, processor, application specific integrated circuits (ASIC), or controller. The processing device 120, 220 can be provided with one or more of a wide variety of components or subsystems including, for example, wired or wireless communication links, input devices (such as touch screen, keyboard, mouse) for user control or input, monitors for displaying information to the user, and/or storage device(s) such as memory, RAM, ROM, DVD, CD-ROM, analog or digital memory, flash drive, database, computer-readable media, and/or hard drive/disks. All or parts of the system, processes, and/or data utilized in the system of the disclosure can be stored on or read from the storage device(s). The storage device(s) can have stored thereon machine executable instructions for performing the processes of the disclosure.

The processing device 120, 220 can execute software that can be stored on the storage device. Unless indicated otherwise, the process is preferably implemented automatically and dynamically by the processor (and the controlled devices) in real time without delay and without manual interaction. Though the central system 100 is described as being central and the remote system 200 is described as being remote, the central system 100 need not be centrally located and the remote system 200 need not be remotely located.

The following references are incorporated by reference. 1—Wan, J.; Zou, C.; Ullah, S.; Lai, C.; Zhou, M.; Wang, X. Cloud-enabled Wireless Body Area Networks for Pervasive Healthcare. IEEE Netw. 2013, 27, 56-61. https://doi: 10.1109/MNET.2013.6616116. 2. Zhang, D.; Wan, J.; Hsu, C.; Rayes, A. Industrial Technologies and Applications for the Internet of Things. Elsevier Comput. Netw. 2016, 101, 1-4. https://doi.org/10.1016/j.comnet.2016.02.019. 3. Zheng Yick, K.; Zhang, Y.; Chen, B. Design of a WSN System for Condition Monitoring of the Mechanical Equipment with Energy Harvesting. Int. J. Online Eng. 2015, 11, 43-48. doi: https://doi.org/10.3991/ijoe.v11i2.4366. 4. Lazarescu, M. T. Design of a WSN Platform for Long-Term Environmental Monitoring for IoT Applications. IEEE J. Emerg. Sel. Top. Circuits Syst. 2013, 3, 45-54. doi: 10.1109/JETCAS.2013.2243032. 5. Liu, L. A Wireless Sensor Network Architecture for Diversiform Deployment Environments. J. Netw. 2011, 6, 482-489. 6. J.; Mukherjee, B.; Ghosal, D. Wireless sensor network survey. Comput. Netw. 2008, 52, 2292-2330. https://doi.org/10.1016/j.comnet.2008.04.002. 7. Millar, R. C., A Multifaceted Investigation and Intervention into the Process of Flight Clearance for UAS Experimental Flight Test, SAE International Journal of Aerospace; Warrendale Vol. 8, Iss. 2, 2015:183-188. 8. Caillouet, Ch. and Mitton, N., Optimization and Communication in UAV Networks, Sensors, 2020, 20, 5036; doi: 10.3390/s20185036. 9. Lan, T.; Qin, D.; Sun, G. Joint Optimization on Trajectory, Cache Placement, and Transmission Power for Minimum Mission Time in UAV-Aided Wireless Networks. ISPRS Int. J. Geo-Inf. 2021, 10, 426.https://doi.org/10.3390/ijgi10070426. 10. Luo, C., Wang, Y., Hong, Y., Chen, W., Ding X., Zhu, Y., Li, D., Minimizing data collection latency with unmanned aerial vehicle in wireless sensor networks, Journal of Combinatorial Optimization, 2019, https://doi.org/10.1007/s10878-019-00434-w. 11. Cao, H., Liu, Y., Yue, X., & Zhu, W. Cloud-Assisted UAV Data Collection for Multiple Emerging Events in Distributed WSNs. Sensors (Basel, Switzerland), (2017), 17 (8), 1818. https://doi.org/10.3390/s17081818.
12. Seo, S., Ko, D., Chung, J., Combined time bound optimization of control, communication, and data processing for FSO-based 6G UAV aerial networks, 2020, Volume 42, Issue 5, Pages: 633-804, DOI: 10.4218/etrij.2020-0210. 13. Sabzehali, J., Shah V. K., Fan Q., Choudhury B., Liu, L., and Jeffrey H. Reed, Optimizing Number, Placement, and Backhaul Connectivity of Multi-UAV Networks, arxiv, 9 Nov. 2021. 14. Bayerlein, H., Theile, M., Caccamo, M., Gesbert, D., Multi-UAV Path Planning for Wireless Data Harvesting with Deep Reinforcement Learning. IEEE Open Journal of the Communications Society, IEEE, 2021, Vol. 2, pp. 1171-1187. 10.1109/OJCOMS.2021.3081996. hal-03219148 15. Zhang, Q., Chen, J., Ji, L., Feng, Z., Han, Z., and Chen, Z., 2020, Response delay optimization in mobile edge computing enabled UAV swarm, IEEE Trans. Veh. Technol. 69, 3280-3295. 16. Asheralieva, A., and Niyato, D., 2019, Game theory and lyapunov optimization for cloud-based content delivery networks with device-to-device and UAV-enabled caching, IEEE Trans. Veh. Technol. 68, 10094-10110.
17. Pan, C., Ren, H., Deng, Y., Elkashlan, M., and Nallanathan, A., Joint Blocklength and Location Optimization for URLLC-enabled UAV Relay Systems, IEEE communication letters, 2019, Vol. 23, No. 3, P 498-50. 18. Cui, J., Ding, Z., Deng, Y. and Nallanathan, A., Model-free based Automated Trajectory Optimization for UAVs toward Data Transmission, 2022, 978-1-7281-0962-6/19/$31.00 ©2019 IEEE. 19. Grekhov, A., Kondratiuk, V., Ilnytska, S. Data Traffic Modeling in RPAS/UAV Networks with Different Architectures. Modelling 2021, 2, 210-223. https://doi.org/10.3390/modelling2020011. 20. Dukkanci, O., Kara, B., Bektas, T., Minimizing energy and cost in range-limited drone deliveries with speed optimization, Transportation Research Part C, vol. 125, 2021https://doi.org/10.1016/j.trc.2021.102985. 21. K. Dorling, J. Heinrichs, G. G. Messier, S. Magierowski, Vehicle routing problems for drone delivery, IEEE Trans. Syst. Man Cybern., (2017). Vol. 47 (1), P 70-85. 22. P. Zhao, H. Tian, C. Qin, and G. Nie, “Energy-saving offloading by jointly allocating radio and computational resources for mobile edge computing,” IEEE Access, June 2017,vol. 5, pp. 11255-11268.
23. A. Balador et al., “Wireless communication technologies for safe cooperative cyber physical systems,” Sensors, vol. 18, no. 11, p. 4075, 2018.doi: 10.3390/s18114075. 24. Allouch, A. Kouba, A. Khalgui, M. and Abbes, T., Qualitative and Quantitative Risk Analysis and Safety Assessment of Unmanned Aerial Vehicles Missions Over the Internet, Multidisciplinary, 2019, Vol. 7, https://doi.org/10.1109/ACCESS.2019.2911980. 25. S. Shen, K. Yang, K. Wang, G. Zhang and H. Mei, “Number and Operation Time Minimization for Multi-UAV-Enabled Data Collection System With Time Windows,” in IEEE Internet of Things Journal, vol. 9, no. 12, pp. 10149-10161, 15 Jun. 15, 2022, doi: 10.1109/JIOT.2021.3121511. 26. M. Samir, S. Sharafeddine, C. M. Assi, T. M. Nguyen, and A. Ghrayeb, “UAV trajectory planning for data collection from time-constrained IoT devices,” IEEE Transactions on Wireless Communications, vol. 19, no. 1, pp. 34-46, 2020. 27. Antonio, P.; Grimaccia, F.; Mussetta, M. Architecture and Methods for Innovative Heterogeneous Wireless Sensor Network Applications. Remote Sens. 2012, 4, 1146-1161. 28. F. Luo, C. Jiang, S. Yu, J. Wang, Y. Li and Y. Ren, “Stability of Cloud-Based UAV Systems Supporting Big Data Acquisition and Processing,” in IEEE Transactions on Cloud Computing, vol. 7, no. 3, pp. 866-877, 1 July-September 2019, doi: 10.1109/TCC.2017.2696529. 29. K. D. Atherton, “THE NAVY PLANS TO LAUNCH SWARMS OF DRONES FROM TUBES,” http://www.popsci.com/navywants-launch-drone-swarms-tubes-video, 2015, [Online; accessed 15 Apr. 2015].
30. Han, P.; Yang, X.; Zhao, Y., Guan, X.; Wang, S. Quantitative Ground Risk Assessment for Urban Logistical Unmanned Aerial Vehicle (UAV) Based on Bayesian Network Sustainability 2022, 14, 5733. https://doi.org/10.3390/su14095733. 31. Joint Authorities for Rulemaking of Unmanned Systems (JARUS). JARUS Guidelines on Specific Operations Risk Assessment (SORA), 2017. Available online: http://jarus-pas.org/content/jar-doc-06-sora-package (accessed on 5 Apr. 2022). 32. Mahmoodi, A., Hashemi, L., Laliberté, J., Millar, R C. Secured Multi-Dimensional Robust Optimization Model for Remotely Piloted Aircraft System (RPAS) Delivery Network Based on the SORA Standard, Designs/MDPI Publication. 2022, 6 (3), 55. https://www.mdpi.com/2411-9660 Jun. 3/55 33. Bonabeau E, Meyer C Swarm intelligence: A whole new way to think about business. Harvard Bus Rev, 2001, 79 (5), 106-115. 34. Puente-Castro, A., Rivero, D., Pazos, A. et al. UAV swarm path planning with reinforcement learning for field prospecting. Appl Intell (2022). https://doi.org/10.1007/s10489-022-03254-4. 35. Mitchell, T. M., Machine Learning (McGraw-Hill International Editions Computer Science Series), McGraw-Hill Education publication, 1997, P 185. 36. J. Kober, J. A. Bagnell, and J. Peters, “Reinforcement learning in robotics: A survey,” International Journal of Robotics Research, vol. 32, no. 11, pp. 1238-1274, 2013.
37. J. Cui, Z. Ding, Y. Deng and A. Nallanathan, “Model-Free Based Automated Trajectory Optimization for UAVs toward Data Transmission,” 2019 IEEE Global Communications Conference (GLOBECOM), 2019, pp. 1-6, doi: 10.1109/GLOBECOM38437.2019.9013644. 38. Kesht gar, Elham, Analysis and Simulation of Robots Optimum Path Panning Based On multi-Objective Reinforcement Learning Algorithms, Ms.c thesis, K. N. Toosi University of Technology Faculty of Electrical and Computer Engineering Department of Computer Science-Artificial Intelligence, Winter 2012. 39. Carrio A., Sampedro, C., Rodriguez-Ramos, A., Campoy, P., “A Review of Deep Learning Methods and Applications for Unmanned Aerial Vehicles”, Journal of Sensors, vol. 2017, Article ID 3296874, 13 pages, 2017. https://doi.org/10.1155/2017/3296874. 40. Coggan, M., Exploration and Exploitation in Reinforcement Learning, CRA-W DMP Project at McGill University, 2004. 41. Nguyen, Th. T., Nguyen, N. D., Vamplew, P., Nahavandi, S., Dazeley, R., Lim., Ch. P., A Multi-Objective Deep Reinforcement Learning Framework, Engineering Applications of Artificial Intelligence, 2020, VOL. 96, 103915, https://doi.org/10.48550/arXiv.1803.02965S.
42. Bardi, M. and Capuzzo-Dolcetta, I., Optimal Control and Viscosity Solutions of Hamilton-Jacobi Bellman Equations. Birkhauser, 1997. 43. Kevorkian, C. G., UAS Risk Analysis using Bayesian Belief Networks: An Application to the Virginia Tech ESPAARO, Master Thesis, the Faculty of the Virginia Polytechnic Institute and State University, 2016, 24-56. 44. Armin Mahmoodi, L. Hashemi, J. Laliberté, R C. Millar, (2022), Secured Multi-Dimensional Robust Optimization Model for Remotely Piloted Aircraft System (RPAS) Delivery Network Based on the SORA Standard, Published in Journal of Designs/MDPI Publication). https://www.mdpi.com/2411-9660/6/3/55. 45. Han, P.; Yang, X.; Zhao, Y., Guan, X.; Wang, S. Quantitative Ground Risk Assessment for Urban Logistical Unmanned Aerial Vehicle (UAV) Based on Bayesian Network. Sustainability 2022, 14, 5733. https://doi.org/10.3390/su14095733. 46. Bareither, C.; Luxhøj J. T. Uncertainty and Sensitivity Analysis in Bayesian Belief Networks: Applications to Aviation Safety Risk Assessment, International Journal of Industrial and Systems Engineering, Vol. 2, No. 2 (2007), pp. 137-158.
47. Washingtona, A.; Clothier, R. A.; Silva, J. A. Review of unmanned aircraft system ground risk models. Prog. Aerosp. Sci. 2017, 95, 24-44. https://doi.org/10.1016/j.paerosci.2017.10.001. 48. Allouch, A. Koubâa, M. Khalgui and T. Abbes, “Qualitative and Quantitative Risk Analysis and Safety Assessment of Unmanned Aerial Vehicles Missions Over the Internet,” in IEEE Access, 2019, vol. 7, pp. 53392-53410, doi: 10.1109/ACCESS.2019.2911980. 49. Das B., Generating conditional probabilities for Bayesian networks: Easing the knowledge acquisition problem, arXiv preprint cs/0411034. 2004 Nov.12. 50. Noriega, A. R., Juárez Ramírez, R., Tapia, J. J., Castillo, V. H., Jiménez, S., Construction of Conditional Probability Tables of Bayesian Networks using Ontologies and Wikipedia, An International Journal of Computing Science and Applications, 2019, Vol. 23, No. 4, https://doi.org/10.13053/cys-23-4-2705. 51. Erkut, E., Ingolfsson, A., Transport risk models for hazardous materials: Revisited. Oper. Res. Lett. 2005, Vol. 33, pp. 81-89. 10.1016/j.orl.2004.02.006.

The description and drawings of the present disclosure provided in the disclosure should be considered as illustrative only of the principles of the disclosure. The disclosure may be configured in a variety of ways and is not intended to be limited by the preferred embodiment. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1-31. (canceled)

32. An unmanned vehicle system comprising:
a plurality of unmanned vehicles (UV), each of said plurality of UVs having a UV processing device; and,
a manned control vehicle having a control vehicle processing device in wireless communication with all of the UV processing devices of all of said plurality of UVs, said control vehicle processing device simultaneously and in real time controlling operation of all of said plurality of UVs during flight of said control vehicle and said plurality of UVs.

33. The system of claim 32, further comprising a UV sensor positioned in each of said plurality of UVs and dynamically detecting in real time a flight condition and/or UV condition, said UV processing device receiving in real time the detected condition and transmitting the detected condition in real time;
said control vehicle processing device receiving in real time the detected condition transmitted by said UV processing device and determining in real time operation of said plurality of UVs based on the detected condition.

34. The system of claim 33, wherein the flight condition comprises an object on the ground or characteristic of an object on the ground.

35. The system of claim 33, wherein the flight condition comprises a hazard.

36. The system of claim 33, wherein the UV condition comprises an altitude or GPS coordinate.

37. The system of claim 32, wherein said control vehicle processing device further dynamically determines in real time operation of said plurality of UV based on a target location.

38. The system of claim 37, wherein said control vehicle processing device positions said plurality of UVs over the target location.

39. The system of claim 32, said control vehicle processing device dynamically controlling operation of said control vehicle in real time.

40. The system of claim 32, said control vehicle processing device dynamically controlling operation of said plurality of UV vehicles in real time.

41. The system of claim 32, said control vehicle further having a rotor, propeller, throttle, flight controller, control sensor, and/or GPS.

42. The system of claim 32, each of said plurality of UVs further having gimball control and flight control systems.

43. The system of claim 33, said UV sensor comprising a radar, LIDAR, and/or imaging.

44. The system of claim 32, wherein said UV comprises an unmanned aerial vehicle.

45. The system of claim 32, wherein said control vehicle comprises a tender.

46. The system of claim 32, wherein said control vehicle processing device coordinates operation of said plurality of UVs and said manned control vehicle.

47. The system of claim 32, wherein said plurality of UVs and said manned control vehicle are aerial vehicles.

48. The system of claim 32, wherein said control vehicle has a control vehicle wireless communication device and each of said plurality of UVs has a UV wireless communication device, and wherein said control vehicle processing device wirelessly communicates via said control vehicle wireless communication device to each of said UV processing devices via said UV wireless communication devices.

49. The system of claim 32, wherein said control vehicle processing device communicates with each of said UV processing devices by radio-frequency signals.

50. The system of claim 32, wherein said control vehicle processing device monitors and manages said plurality of UVs.

51. The system of claim 32, wherein said control vehicle processing device determines a flight plan, transmits the flight plan to said UV processing devices to control operation of said plurality of UVs to coordinate operation of all of said plurality of UVs.

52. The system of claim 51, wherein each of said UV processing devices receive the flight plan from said control vehicle processing device and said UV processing device controls operation of said UV based on the flight plan.

53. The system of claim 51, wherein said control processing device controls operation of said control vehicle based on the flight plan.

54. The system of claim 51, wherein said plurality of UVs has a UV flight controller and said UV flight controller controls operation of said UV.

55. The system of claim 54, wherein said UV flight controller receives the flight plan and controls operation of said UV based on the flight plan.

56. The system of claim 51, wherein said control vehicle has a control vehicle flight controller and said control vehicle flight controller controls operation of said control vehicle.

57. The system of claim 56, wherein said control flight controller generates the flight plan or receives the flight plan from said control vehicle processing device.

58. The system of claim 32, wherein each of said plurality of UVs has a different flight path and/or mission, and the flight plan is configured based on the flight path and/or mission of said plurality of UVs.

59. The system of claim 32, further comprising a ground station with a ground station processing device configured to generate a flight plan, transmit the flight plan to said control device processing device and/or said UV processing devices to control operation of said control device and said plurality of UVs to coordinate operation of all of said plurality of UVs and said control device.

60. The system of claim 32, said ground station processing device or said control processing device having a risk assessment model configured to determine risk indicators using an integrated SORA-BBN (Specific Operation Risk Assessment-Bayesian Belief Network) approach while its resultant analysis is weighted through the Analytic Hierarchy Process (AHP) ranking model.

61. The system of claim 60, said ground station processing device or said control processing device configured as a convex optimization model and a low complexity Multi-Objective Reinforcement Learning (MORL) algorithm to map UV device to make optimal movement decisions.

62. The system of claim 32, further comprising a UAV-assisted data network configured to provide coverage for the Internet of Things (IoT).
